(19) United States
(12) Patent Application Publication
(10) Pub. No.: US 2013/0335980 A1
(43) Pub. Date: Dec. 19, 2013

(54) LIGHT EMITTING DEVICE AND LIGHTING FIXTURE

(71) Applicant: PANASONIC CORPORATION, Osaka (JP)

(72) Inventors: Takeshi NAKASUJI, Osaka (JP); Jun TAKASHIMA, Osaka (JP)

(21) Appl. No.: 13/915,868

(22) Filed: Jun. 12, 2013

(30) Foreign Application Priority Data
Jun. 13, 2012 (JP) 2012-133804
Jun. 13, 2012 (JP) 2012-133806

(51) Int. Cl. F21V 3/00

(52) U.S. Cl. CPC F21V 3/005
USPC 362/341; 362/375

(57) ABSTRACT

The light emitting device in accordance with the present invention includes a light emitter; a lighting circuit unit including a circuit component for lighting the light emitter; and a housing configured to accommodate the light emitter and the lighting circuit unit. The housing is constituted by: a substrate on which the light emitter and the lighting circuit unit are placed; and a cover attached to the substrate to cover the light emitter and the lighting circuit unit.

### TECHNICAL FIELD

The present invention relates to light emitting devices and lighting fixtures.

### BACKGROUND ART

In the past, various kinds of light emitting devices for lighting light emitters have been developed and available commercially (see document 1 [JP 2010-129488 A]). As for the light emitting device disclosed in document 1, a circuit board on which lighting circuit components are mounted is placed on a rear side of an LED substrate on which a light emitting diode (LED) is mounted. Each of the LED substrate and the circuit board is fixed in contact with a heat dissipater.

As mentioned above, the prior light emitting device disclosed in document 1 can dissipate heat generated by the LED and the lighting circuit components. However, the LED and the lighting circuit components are covered by resin only. Hence, to protect the LED and the lighting circuit components, a housing for covering the LED and the lighting circuit components is necessary. Accordingly, the prior light emitting device can not satisfy both of improvement in heat dissipation performance and reduction in the number of parts thereof.

### SUMMARY OF INVENTION

In view of the above insufficiency, the present invention has aimed to propose a light emitting device and a lighting fixture which can satisfy both of improvement in heat dissipation performance and reduction in the number of parts thereof.

The light emitting device of the first aspect in accordance with the present invention includes a light emitter; a lighting circuit unit including a circuit component for lighting the light emitter; and a housing configured to accommodate the light emitter and the lighting circuit unit. The housing is constituted by a substrate on which the light emitter and the lighting circuit unit are placed; and a cover attached to the substrate to cover the light emitter and the lighting circuit unit.

As for the light emitting device of the second aspect in accordance with the present invention, in addition to the first aspect, the light emitter is placed on a first surface of the substrate in a thickness direction of the substrate. The lighting circuit unit is placed on a vicinity of the lighting emitter.

As for the light emitting device of the third aspect in accordance with the present invention, in addition to the first or second aspect, the light emitter and the lighting circuit unit are placed on a first surface of the substrate in a thickness direction of the substrate. The substrate includes a light emitter supporting portion defined as a portion on which the light emitter is placed; a circuit supporting portion defined as a portion on which the lighting circuit unit is placed; and an uneven portion which has a level difference in the thickness direction and is interposed between the light emitter supporting portion and the circuit supporting portion.

As for the light emitting device of the fourth aspect in accordance with the present invention, in addition to the third aspect, the uneven portion is defined by a surface connecting a first surface of the light emitter supporting portion on which the light emitter is placed and a first surface of the circuit supporting portion on which the lighting circuit unit is placed such that the first surface of the light emitter supporting portion on which the light emitter is placed and the first surface of the circuit supporting portion on which the lighting circuit unit is placed are positioned at mutually different positions in the thickness direction.

As for the light emitting device of the fifth aspect in accordance with the present invention, in addition to the third aspect, the uneven portion is defined by a recessed part.

As for the light emitting device of the sixth aspect in accordance with the present invention, in addition to any one of the first to fifth aspects, the circuit component is placed on the substrate.

As for the light emitting device of the seventh aspect in accordance with the present invention, in addition to any one of the first to sixth aspects, the light emitter comprises an LED element.

As for the light emitting device of the eighth aspect in accordance with the present invention, in addition to any one of the first to seventh aspects, the substrate has a first surface and a second surface in a thickness direction of the substrate. The light emitter is placed on the first surface of the substrate. The second surface of the substrate is a flat surface.

As for the light emitting device of the ninth aspect in accordance with the present invention, in addition to any one of the first to seventh aspects, the substrate has a first surface and a second surface in a thickness direction of the substrate. The light emitter is placed on the first surface of the substrate. The substrate is provided at the second surface with a recessed and protruded structure.

As for the light emitting device of the tenth aspect in accordance with the present invention, in addition to any one of the first to ninth aspects, the light emitter is placed on a first surface of the substrate in a thickness direction of the substrate. The cover includes a first part which is placed on the first surface of the substrate to cover the light emitter and is designed to allow light from the light emitter to pass; a second part placed on the first surface of the substrate to not cover the light emitter; and a light reflector which is formed on a surface of the second part and is designed to reflect light from the light emitter.

The lighting fixture of the eleventh aspect in accordance with the present invention, includes a light emitting device according to any one of the first to tenth aspects; and a fixture body configured to support the light emitting device.

### BRIEF DESCRIPTION OF THE DRAWINGS

FIG. 1 is a sectional view illustrating the light emitting device in accordance with the first embodiment,

FIG. 2 is a front view illustrating the light emitting device in accordance with the first embodiment,

FIG. 3A is a sectional view illustrating the lighting fixture in accordance with the first embodiment,

FIG. 3B is a sectional view illustrating the lighting fixture in accordance with the first embodiment,

FIG. 4A is a sectional view illustrating the modification of the lighting fixture in accordance with the first embodiment,

FIG. 4B is a sectional view illustrating the modification lighting fixture in accordance with the first embodiment,

FIG. 5 is a sectional view illustrating the first modification of the lighting fixture in accordance with the first embodiment,

FIG. 6 is a sectional view illustrating the second modification of the lighting fixture in accordance with the first embodiment,

FIG. 7 is a sectional view illustrating the third modification of the lighting fixture in accordance with the first embodiment,

FIG. 8 is a sectional view illustrating the fourth modification of the lighting fixture in accordance with the first embodiment,

FIG. 9 is a sectional view illustrating the lighting fixture in accordance with the second embodiment,

FIG. 10 is a sectional view illustrating the first modification of the lighting fixture in accordance with the second embodiment,

FIG. 11 is a sectional view illustrating the second modification of the lighting fixture in accordance with the second embodiment,

FIG. 12 is a sectional view illustrating the third modification of the lighting fixture in accordance with the second embodiment,

FIG. 13 is a sectional view illustrating the lighting fixture in accordance with the third embodiment,

FIG. 14 is a sectional view illustrating the modification of the lighting fixture in accordance with the third embodiment,

FIG. 15 is a sectional view illustrating the lighting fixture in accordance with the fourth embodiment,

FIG. 16 is a sectional view illustrating the modification of the lighting fixture in accordance with the fourth embodiment,

FIG. 17 is a sectional view illustrating the light emitting device in accordance with the fifth embodiment,

FIG. 18 is a front view illustrating the light emitting device in accordance with the fifth embodiment,

FIG. 19A is a sectional view illustrating the lighting fixture in accordance with the fifth embodiment,

FIG. 19B is a sectional view illustrating the lighting fixture in accordance with the fifth embodiment,

FIG. 20A is a sectional view illustrating the modification of the lighting fixture in accordance with the fifth embodiment,

FIG. 20B is a sectional view illustrating the modification lighting fixture in accordance with the fifth embodiment,

FIG. 21 is a sectional view illustrating the first modification of the lighting fixture in accordance with the fifth embodiment,

FIG. 22 is a sectional view illustrating the second modification of the lighting fixture in accordance with the fifth embodiment,

FIG. 23 is a sectional view illustrating the third modification of the lighting fixture in accordance with the fifth embodiment,

FIG. 24 is a sectional view illustrating the lighting fixture in accordance with the sixth embodiment,

FIG. 25 is a sectional view illustrating the first modification of the lighting fixture in accordance with the sixth embodiment,

FIG. 26 is a sectional view illustrating the second modification of the lighting fixture in accordance with the sixth embodiment,

FIG. 27 is a sectional view illustrating the third modification of the lighting fixture in accordance with the sixth embodiment,

FIG. 28 is a sectional view illustrating the lighting fixture in accordance with the seventh embodiment,

FIG. 29 is a sectional view illustrating the first modification of the lighting fixture in accordance with the seventh embodiment,

FIG. 30 is a sectional view illustrating the second modification of the lighting fixture in accordance with the seventh embodiment,

FIG. 31 is a sectional view illustrating the third modification of the lighting fixture in accordance with the seventh embodiment,

FIG. 32 is a sectional view illustrating the fourth modification of the lighting fixture in accordance with the seventh embodiment,

FIG. 33 is a sectional view illustrating the fifth modification of the lighting fixture in accordance with the seventh embodiment,

FIG. 34 is a sectional view illustrating the sixth modification of the lighting fixture in accordance with the seventh embodiment,

FIG. 35 is a sectional view illustrating the lighting fixture in accordance with the eighth embodiment, and

FIG. 36 is a sectional view illustrating the modification of the lighting fixture in accordance with the eighth embodiment,

### DESCRIPTION OF EMBODIMENTS

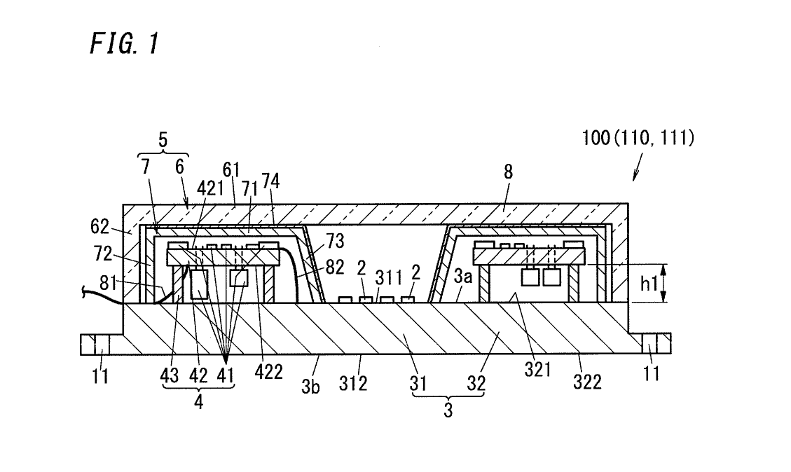

With regard to the following first to fourth embodiments, for example, a light emitting device 100 shown in FIG. 1 has a structure in which a light emitter 2 and a lighting circuit unit 4 are placed on a substrate 3. In this light emitting device 100, part of the substrate 3 serves as part of a housing 8. In brief, the light emitting device 100 has the housing 8 constituted by the substrate 3 and a cover 5. Further, the substrate 3 constituting part of the housing 8 radiates heat generated by the light emitter 2 and the lighting circuit unit 4 via a portion in contact with an outside thereof.

The following explanations are made to the respective embodiments.

### First Embodiment

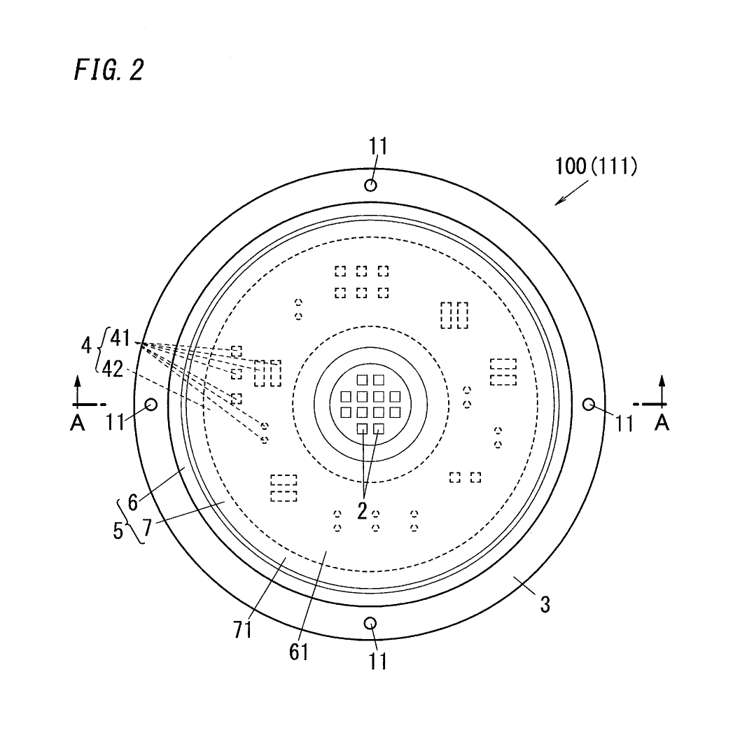

FIG. 2 shows a front view of the light emitting device 100 (110) in accordance with the present embodiment, and FIG. 1 shows a sectional view along line A-A in FIG. 2. Note that, FIG. 1 illustrates a basic example (light emitting device 111) regarding the light emitting device 110 of the first embodiment.

As shown in FIG. 1, the light emitting device 111 in accordance with the first embodiment includes the light emitter 2, the substrate 3 having a first surface 311 on which the light emitter 2 is mounted, the lighting circuit unit 4 placed on a first surface 321 of the substrate 3, and the cover 5 designed to cover the light emitter 2 and the lighting circuit unit 4. Further, the light emitting device 111 includes a first wire 81 for electrically connecting the lighting circuit unit 4 to an external power supply (not shown) and a second wire 82 for electrically connecting the lighting circuit unit 4 to the light emitter 2. FIG. 1 illustrates an example in which the plural light emitters 2 are mounted on the substrate 3.

The light emitter 2 includes an LED element, a transparent resin member for increasing light extraction efficiency regarding the LED element, and a fluorescent member for converting a wavelength of light from the LED element, which are not shown. Note that, the light emitter 2 may be an LED package in which the LED element and the fluorescent member are formed integrally. In brief, the light emitter 2 may include an LED element.

The LED element emits light such as ultraviolet light, purple light, blue light, and green light. This LED element is bonded and fixed to the substrate in a die-bonding manner, and is electrically connected to a wiring layer (not shown) of the substrate 3 via a wire (not shown) such as a bonding wire.

The transparent resin member is formed of silicone, for example. The transparent resin member is provided to a light emission side of the LED element, and increases the light extraction efficiency regarding the LED element.

Note that, the light emitter 2 may be a combination of red, green and blue LED elements. Alternatively, the light emitter 2 may be a combination of a set of the LED element and the fluorescent member and one or more additional LED elements selected from purple, blue, green, yellow, orange, and red LED elements.

The substrate 3 is constituted by a ceramic substrate. The ceramic substrate may be formed of aluminum nitride, alumina, mullite, and cordierite.

The substrate 3 includes a light emitter supporting portion 31 on which the light emitter 2 is mounted and a circuit supporting portion 32 on which the lighting circuit unit 4 is placed. The light emitter supporting portion 31 and the circuit supporting portion 32 are formed integrally with each other. As shown in FIG. 2, the substrate 3 is formed into a circular shape.

The substrate 3 has opposite surfaces in a thickness direction (upward and downward direction in FIG. 1), and one of the opposite surfaces defines a first surface (upper surface in FIG. 1) 3a and the other defines a second surface (lower surface in FIG. 1) 3b. The substrate 3 includes the light emitter supporting portion 31 and the circuit supporting portion 32. The light emitter supporting portion 31 is defined by a portion of the substrate 3 on which the light emitter 2 is placed. In other words, the light emitter supporting portion 31 is defined by a potion for supporting the light emitter 2. The circuit supporting portion 32 is defined by a portion of the substrate 3 on which the lighting circuit unit 4 is placed. In other words, the circuit supporting portion 32 is defined by a potion for supporting the lighting circuit unit 4. The light emitter supporting portion 31 has the first surface 311 which is part of the first surface 3a of the substrate 3, and a second surface 312 which is part of the second surface 3b of the substrate 3. The circuit supporting portion 32 has the first surface 321 which is part of the first surface 3a of the substrate 3, and a second surface 322 which is part of the second surface 3b of the substrate 3.

For example, the substrate 3 has a central part and a vicinity of the central part, the central part used as the light emitter supporting portion 31 and the vicinity used as the circuit supporting portion 32. In the present embodiment, contact positions of the substrate 3 and each of a first cover 6 and a second cover 7 of the cover 5 are on the first surface 321 of the circuit supporting portion 32.

In the substrate 3, a mounting surface for an LED element, that is, the first surface 311, is designed to reflect light from the LED element at high efficiency. Concretely, the reflectance of the first surface 311 for light with a wavelength in a range of 380 nm to 780 nm (visible range) is not less than 85% when the substrate 3 has a thickness of 1 mm.

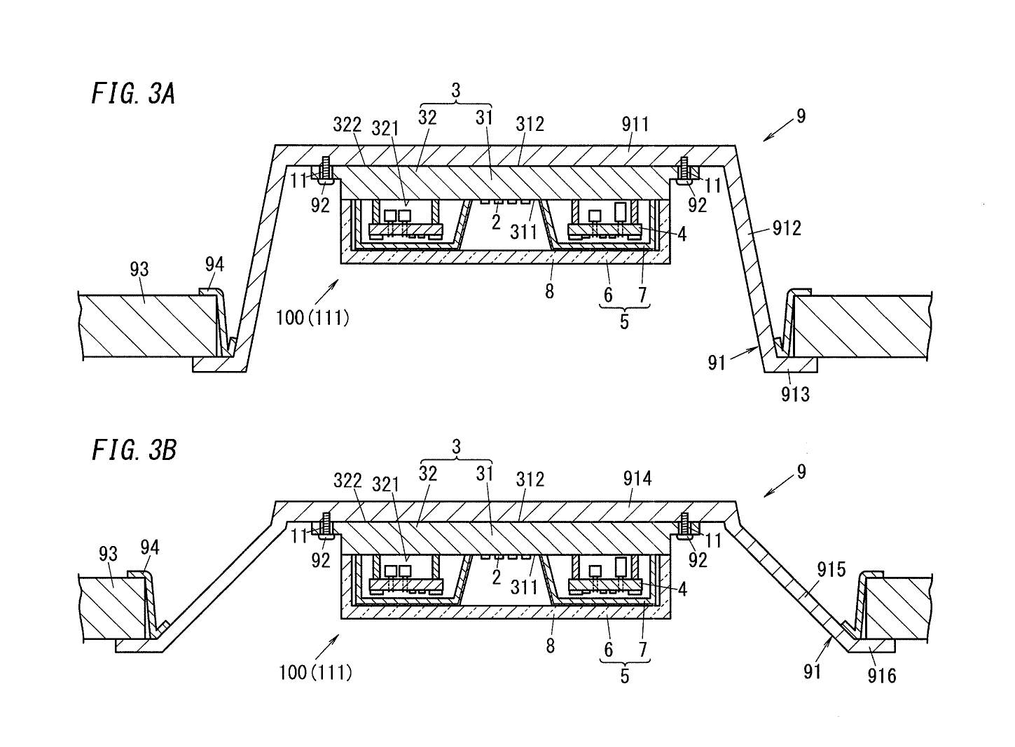

It is preferred that the second surface 3b (312, 322) of the substrate 3 have a flatness in a range of 0.01 to 0.08. When the flatness of the second surface 3b (312, 322) of the substrate 3 exceeds 0.08, and when the light emitting device 100 is attached to a fixture body 91 (see FIG. 3), a thermal resistance between the substrate 3 and an attaching surface of the fixture body 91 is likely to become relatively high. Hence, it is difficult to efficiently dissipate heat generated by the LED element to the fixture body 91. In contrast, when the flatness of the second surface 3b (312, 322) of the substrate 3 falls below 0.01, a processing cost for the substrate 3 is likely to extremely increase.

It is preferred that the substrate 3 have an average surface roughness (Ra) in a range of 0.3 to 0.8. When the average surface roughness exceeds 0.8, printing performance for the wiring layer formed on the substrate 3 is deteriorated, and it is difficult to form a fine pitch patterned wire. In contrast, when the average surface roughness of the substrate 3 falls below 0.3, junction strength between the substrate 3 and the wiring layer is likely to decrease and thus the wiring layer may be easily detached from the substrate 3. Note that, it is preferred that the substrate 3 be directly fixed to the fixture body 91 (see FIG. 3) such that there is no gap between the substrate 3 and the fixture body 91. When the junction surfaces of the substrate 3 and the fixture body 91 have the insufficient average surface roughness (Ra) and the insufficient flatness, a thermally conductive material may be interposed between the substrate 3 and the fixture body 91. The thermally conductive material may be grease.

Further, to increase the heat dissipation performance (property), it is preferred that the substrate 3 have the thermal emissivity not less than 0.9. Similarly, to increase the heat dissipation performance (property), it is preferred that the substrate 3 have the head conductivity (at 25° C.) not less than 19 W/mK.

The wiring layer (not shown) of the substrate 3 is made of metal (e.g., copper [Cu], silver [Ag], gold [Au], and aluminum [Al]) or conductive material primarily including the metal. The wiring layer (not shown) is formed by means of plating, printing, or deposition.

The lighting circuit unit 4 includes plural circuit components 41, a circuit board 42 on which the plural circuit components 41 are mounted, and plural pillars 43 for supporting the circuit board 42. The lighting circuit unit 4 is placed on a vicinity of the light emitter 2. For example, the lighting circuit unit 4 is provided to the vicinity of the light emitter 2 on the first surface 321 of the substrate 3.

The plural circuit components 41 constitute a lighting circuit for supplying electrical power to the light emitter 2 to light the light emitter 2.

The circuit board 42 is constituted by a ceramic substrate. The ceramic substrate may be formed of aluminum nitride, alumina, mullite, and cordierite. The plural circuit components 41 are mounted on opposite surfaces of the circuit board 42. Some circuit components 41 are located on a second surface (lower surface in FIG. 1) 422 side of the circuit board 42, and are fixed on a first surface (upper surface in FIG. 1) 421 of the circuit board 42 at their terminals which exposed on the first surface via through holes formed in the circuit board 42. Note that, the circuit component 41 may be located on only either the first surface 421 side or the second surface 422 side of the circuit board 42. Further, as shown in FIG. 2, the circuit board 42 is formed into a circular shape. The circuit board 42 has an outer diameter less than that of the substrate 3.

The pillar 43 is a member supporting the circuit board 42 such that the circuit board 42 is away from the substrate 3. The pillars 43 are arranged at plural positions on the circuit board 42. The pillar 43 has one end fixed to the substrate 3 and the other end fixed to the circuit board 42. The pillar 43 is fixed to the substrate 3 by use of adhesive, for example. Thus, the circuit board 42 on which the plural circuit components 41 are mounted is fixed to the substrate 3 by use of the pillars 43. The pillar 43 has a height h1 selected such that the circuit component 41 is not in contact with the substrate 3. Note that, thermally conductive sheet (not shown) with an electrical insulation property may be interposed between the circuit component 41 and the substrate 3.

Note that, the lighting circuit unit 4 may be provided with a power supply circuit. In this arrangement, when coupled to an external commercial power source, the lighting circuit unit 4 can light the light emitter 2. It is possible to facilitate power supply to a lighting fixture 9 (see FIG. 3) from an external device.

The cover 5 of the present embodiment is constituted by the first cover 6 designed to entirely cover the first surfaces 311 and 321 of the substrate 3, and the second cover 7 designed to cover the lighting circuit unit 4.

The first cover 6 is defined as a first part which is placed on the first surface 3a of the substrate 3 to cover the light emitter 2 and is configured to allow light from the light emitter 2 to pass. The first cover 6 includes an upper surface part 61 and a side part 62 which are formed integrally with each other. The upper surface part 61 is formed into a circular shape (see FIG. 2). The side part 62 is formed into a cylindrical shape and extends downward from a periphery of the upper surface part 61. Thus, the first cover 6 is formed into a hollow cylindrical shape with a bottom. The first cover 6 is attached to the substrate 3 by fixing the side part 62 to a periphery of the substrate 3 by use of adhesive or screws, for example.

The first cover 6 has a portion which receives light from the light emitter 2, and such a portion is made of transparent or light diffusing glass or synthetic resin with a light transmissive property. The first cover 6 of the present embodiment has light diffusion property to diffuse light. Therefore, the first cover 6 can diffuse light from the light emitter 2, thereby radiating the light to the outside. Hence, color unevenness and a grainy appearance can be reduced. So long as a user ignores the color unevenness and the grainy appearance, the first cover 6 need not necessarily have the light diffusion property. For example, the first cover 6 may be transparent.

Note that, the first cover 6 may contain a fluorescent member converting a wavelength of light from the LED element.

Further, the first cover 6 may be a combination of a flat plate part and a hollow cylindrical part. In this case, the flat plate part may be made of transparent material, and the hollow cylindrical part may be made of opaque material.

The second cover 7 is defined as second part placed on the first surface 3a of the substrate 3 to not cover the light emitter 2. In the present embodiment, the second cover (second part) 7 is placed to cover the lighting circuit unit 4 without covering the light emitter 2. The second cover 7 includes an upper surface part 71, an outer side part 72, and an inner side part 73 which are formed integrally with each other. The upper surface part 71 is formed into a circular ring shape (see FIG. 2). The outer side part 72 is formed into a hollow cylindrical shape and extends downward from an outer periphery of the upper surface part 71. The inner side part 73 is formed into a hollow cylindrical shape and extends downward from an inner periphery of the upper surface part 71. The second cover 7 is formed into a hollow cylindrical shape with a bottom. The inner side part 73 is formed into a tapered shape such that an inside of the inner side part 73 becomes narrower toward an apex side (lower side) than at the upper surface part 7 side (upper side). The second cover 7 is attached to the substrate 3 by fixing an apex of the outer side part 72 to the periphery of the substrate 3 and an apex of the inner side part 73 to part of the substrate 3 by use of adhesive or screws, for example.

Further, the second cover 7 has a part which receives light from the light emitter 2, and a light reflector (high reflective coating) 74 is formed on such a part. Concretely, the light reflector 74 is formed on outer surfaces of the upper surface part 71 and the inner side part 73. Thus, light from the light emitter 2 can be reflected by the light reflector 74. Hence, it is possible to prevent radiation of light from the light emitter 2 toward the inside of the second cover 7, that is, the lighting circuit unit 4.

In brief, the light reflector 74 is formed on the surface (outer surface) of the second cover (second part) 7 and is designed to reflect light from the light emitter 2.

The first wire 81 from the lighting circuit unit 4 is connected to an external power supply (not shown) via a gap (not shown) formed between the substrate 3 and the cover 5 (the first cover 6 and the second cover 7). Further, the second wire 82 from the lighting circuit unit 4 is electrically connected to the light emitter 2 through the wiring layer (not shown) of the substrate 3. Consequently, the lighting circuit unit 4 can receive power from the external power supply and supply power to the light emitter 2 to light the light emitter 2.

Note that, a connection between the lighting circuit unit 4 and the external power supply may be made by forming an electrode (not shown) for making an electrical connection with the external power supply on the first surface 321 of the substrate 3 and connecting the lighting circuit unit 4 to the substrate 3 via the first wire 81. In this case, the lighting circuit unit 4 and the external power supply can be electrically connected to each other through the wiring layer and the electrode. Alternatively, the electrode may be formed on the second surface 322 of the substrate 3. In this case, the lighting circuit unit 4 and the external power supply may be electrically connected to each other by use of a through-hole electrode (not shown) communicating between the first surface 321 and the second surface 322.

As shown in FIG. 3, the light emitting device 111 explained above is attached to the fixture body 91 and is used as the lighting fixture 9. The lighting fixture 9 is, for example, a lighting fixture for residences or premises (e.g., a downlight). Note that, the application of the lighting fixture 9 is not limited to the aforementioned application, but the lighting fixture 9 may be an apparatus suitable for another application.

For example, the fixture body 91 is made of metal. As shown in FIG. 3A, the fixture body 91 includes a flat plate part 911, a side part 912, and an apex part 913 which are formed integrally with each other. The flat plate part 911 is formed into a circular shape. The side part 912 extends downward from a periphery of the flat plate part 911. The apex part 913 extends outward from an end of the side part 912. The side part 912 is formed into a tapered shape such that an inside thereof becomes greater toward the apex part 913 than at the flat plate part 911. The fixture body 91 is fixed to a ceiling 93 by use of ceiling fixing springs 94.

With regard to the fixture body 91, the flat plate part 911 is made of a polished Al die-casting part such that a contact surface to the substrate 3 (i.e., a surface beneath the light emitter 2) has a light reflective property. Alternatively, a high reflective coating may be formed on a surface of the fixture body 91. The high reflective coating may be made of inorganic metal such as silver (Ag) and aluminum (Al) or organic material such as barium sulfate.

Fixing the light emitting device 111 to the flat plate part 911 of the fixture body 91 is made by use of screws 92. Screw holes (attachment holes) 11 for passing the screws 92 are formed in a part of the substrate 3 of the light emitting device 111 which is not covered by the first cover 6. The flat plate part 911 is provided with internal threads for receiving the screws 92. The aforementioned fixing may be made by use of bolts and nuts. Alternatively, the light emitting device 111 may be provided with a base and the fixture body 91 may be provided with a supporting member formed into a socket shape. The light emitting device 111 may be fixed to the fixture body 91 by inserting the base into the supporting member and screwing or fitting one to the other (e.g., a bayonet structure and a catching structure)

The ceiling 93 may be formed into a shape shown in FIG. 3B. The fixture body 91 shown in FIG. 3B includes a flat plate part 914, a side part 915, and an apex part 916 which are formed integrally with each other. The flat plate part 914 is formed into a circular shape. The side part 915 extends downward from a periphery of the flat plate part 914. The apex part 916 extends outward from an end of the side part 915. The side part 915 is formed such that an inside thereof becomes greater toward the apex part 916 side than at the flat plate part 914 side, and an increasing rate of the inside of the side part 915 from an intermediate part of the side part 915 to the apex part 916 side is greater than that from the flat plate part 914 side to the intermediate part. The fixture body 91 shown in FIG. 3B has a lower height and a flat shape relative to the fixture body 91 shown in FIG. 3A.

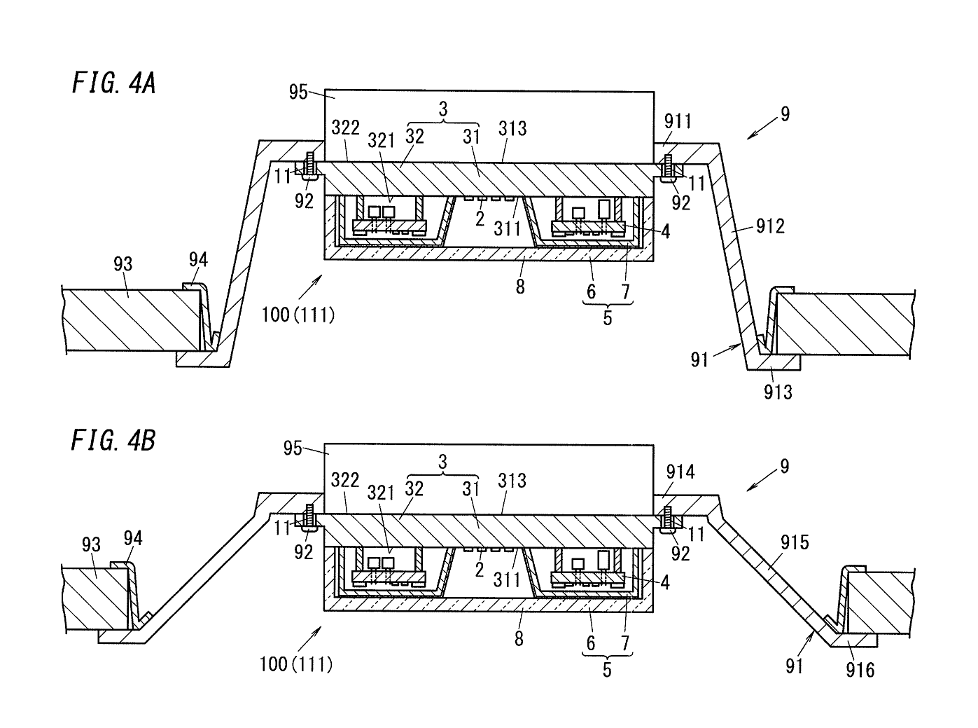

Alternatively, FIG. 4A and FIG. 4B show another example (modification) of the lighting fixture 9 of the present embodiment which further includes a heatsink 95. The heatsink 95 is provided to the fixture body 91. In the lighting fixture 9 shown in FIG. 4, the substrate 3 of the light emitting device 111 is in direct contact with the heatsink 95 when the light emitting device 111 is attached to the fixture body 91. Hence, heat dissipation via the substrate 3 can be improved.

The following explanation is made to other examples (modifications) of the light emitting device 110 in accordance with the present embodiment.

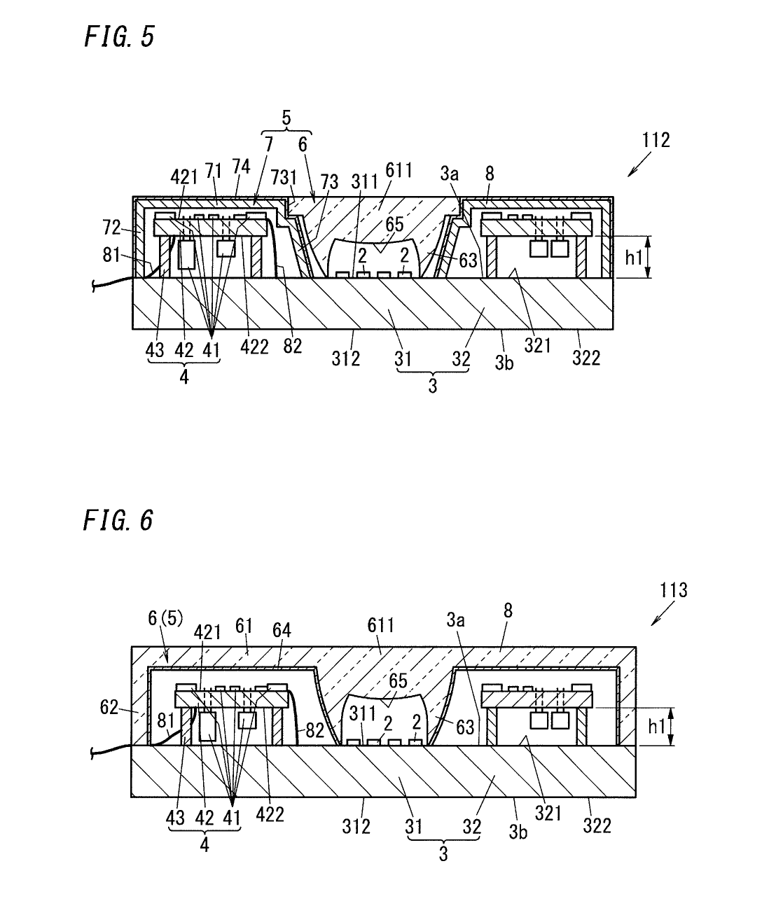

FIG. 5 shows a first modification (light emitting device 112) of the light emitting device 110 of the present embodiment. The light emitting device 112 of FIG. 5 has a structure in which the first cover 6 is designed to cover only the light emitter 2 and the second cover 7 is designed to cover only the lighting circuit unit 4. In this structure, the cover 5 is considered as covering the light emitter 2 and the lighting circuit unit 4.

The first cover 6 of FIG. 5 does not include the side part 62, but includes a protrusion part 63 formed integrally with the upper surface part 61. The protrusion part 63 is formed into a hollow cylindrical shape and extends downward from a central part 611 of the upper surface part 61. The first cover 6 is fixed to the substrate 3 such that the light emitter 2 is housed in a space surrounded by the protrusion part 63. Further, in the first cover 6, a periphery of the upper surface part 61 is fitted into a fitting part 731 of the second cover 7. Note that, in FIG. 5, the parts provided with the screw holes 11 (see FIG. 1) are not shown. In the following FIG. 6 to FIG. 8, similarly, such parts are not shown.

FIG. 6 shows a second modification (light emitting device 113) of the light emitting device 110 of the present embodiment. In the light emitting device 113 of FIG. 6, the cover 5 does not include the second cover 7 but includes only the first cover 6. In this structure, the cover 5 is considered as covering the light emitter 2 and the lighting circuit unit 4.

In a similar manner as the first cover 6 of FIG. 5, the first cover 6 of FIG. 6 includes the protrusion part 63 formed integrally with the upper surface part 61. The protrusion part 63 is formed into a hollow cylindrical shape and extends downward from the central part 611 of the upper surface part 61. The first cover 6 is fixed to the substrate 3 such that the light emitter 2 is housed in the space surrounded by the protrusion part 63. With regard to the first cover 6, a light reflector 64 is formed on a partition which separates the light emitter 2 from the lighting circuit unit 4. Namely, the light reflector 64 is formed on an outer surface of the protrusion part 63. The light reflector 64 is, for example, a high reflective coating made of inorganic metal such as silver (Ag) and aluminum (Al) or organic material such as barium sulfate.

With regard to the first cover 6 of FIG. 6, the protrusion part 63 serves as the first part which is placed on the first surface 3a of the substrate 3 to cover the light emitter 2 and is designed to allow light from the light emitter 2 to pass. Further, the side part 62 and part of the upper surface part 61 other than the central part 611 serve as the second part placed on the first surface 3a of the substrate 3 to not cover the light emitter 2. The light reflector 64 is formed on the surface (inner surface) of the second part and is designed to reflect light from the light emitter 2.

In the light emitting devices 112 and 113 of FIG. 5 and FIG. 6, the first cover 6 includes a part 65 located above the light emitter 2, and the part 65 serves as a lens. Therefore, the number of parts thereof can be reduced relative to an example in which a separated lens is provided to the first cover 6.

Further, in the light emitting device 113 of FIG. 6, since the first cover 6 is devoid of the second cover 7, and includes only the first cover 6, the number of parts can be reduced relative to the light emitting device 112 of FIG. 5.

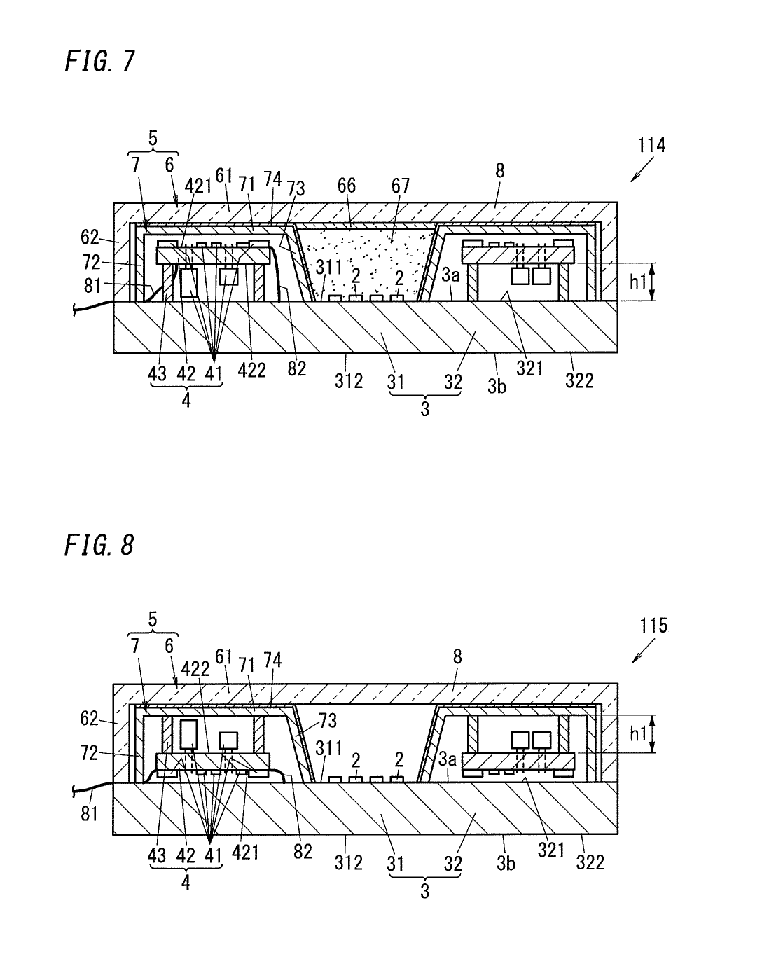

FIG. 7 shows a third modification (light emitting device 114) of the light emitting device 110 of the present embodiment. In the light emitting device 114 of FIG. 7, a fluorescent layer 7 is formed on a part of the first cover 6 which passes light from the light emitter 2 to the outside. The fluorescent layer 66 converts a wavelength of light from the light emitter 2. The light emitter 2 is encapsulated with a transparent resin 67. The transparent resin 67 is, for example, silicone resin.

Alternatively, instead of the fluorescent layer 66, a fluorescent sheet may be located on the part of the first cover 6 which passes light from the light emitter 2 to the outside. In this case, with arbitrarily changing fluorescent material contained in the fluorescent layer 66 or the fluorescent sheet, it is possible to convert a wavelength of light form the light emitter 2 into a desired wavelength.

FIG. 8 shows a fourth modification (light emitting device 115) of the light emitting device 110 of the present embodiment. In the light emitting device 115 of FIG. 8, the lighting circuit unit 4 is mounted on not the substrate 3 but the second cover 7. Thus, the lighting circuit unit 4 is placed on the first surface 321 of the substrate 3 by mounting on the second cover 7 (the lighting circuit unit 4 is placed on the vicinity of the light emitter 2 by use of the second cover 7). Consequently, in contrast to a case where the lighting circuit unit 4 is (directly) mounted on the substrate 3, it is possible to inhibit transfer of heat generated by the light emitter 2 to the lighting circuit unit 4. Note that, the height h1 of the pillar 43 is selected such that the circuit component 41 is not in contact with the second cover 7.

In the light emitting device 110 (111 to 115) of the present embodiment explained above, part of the substrate 3 on which the light emitter 2 and the lighting circuit unit 4 are mounted constitutes part of the housing 8. Hence, heat can be dissipated to the outside via the substrate 3 without using a heat dissipater. Consequently, in contrast to a configuration where a substrate does not constitute a housing, the light emitting device 110 (111 to 115) of the present embodiment can have the improved heat dissipation performance for heat from the light emitter 2 and the lighting circuit unit 4.

Further, according to the light emitting device 110 (111 to 115) of the present embodiment, the housing 8 can be constituted by the substrate 3 and the cover 5. Hence, a housing separate from the substrate 3 and the cover 5 is unnecessary.

Accordingly, the light emitting device 110 (111 to 115) of the present embodiment can satisfy improvement in heat dissipation performance and reduction in the number of parts thereof.

As mentioned above, the light emitting device 100 (110) of the present embodiment includes the following first to fifth features. Note that, the second to fifth features are optional.

As for the first feature, the light emitting device 110 includes the light emitter 2; the substrate 3 having the first surface 3a on which the light emitter 2 is placed; the lighting circuit unit 4 which includes the circuit component 41 for lighting the light emitter 2 and is placed on the substrate 3; and the cover 5 configured to cover the light emitter 2 and the lighting circuit unit 4. The substrate 3 has a part which constitutes part of the housing 8.

In other words, the light emitting device 110 includes the light emitter 2; the lighting circuit unit 4 including the circuit component 41 for lighting the light emitter 2; and the housing 8 configured to accommodate the light emitter 2 and the lighting circuit unit 4. The housing 8 is constituted by: the substrate 3 on which the light emitter 2 and the lighting circuit unit 4 are placed; and the cover 5 attached to the substrate 3 to cover the light emitter 2 and the lighting circuit unit 4.

As for the second feature, in the first feature, the lighting circuit unit 4 is placed on a vicinity of an area of the substrate 3 on which the light emitter 2 is placed, and is placed on a space between the cover 5 and the substrate 3. In other words, the light emitter 2 is placed on the first surface 3a of the substrate 3 in the thickness direction of the substrate 3. The lighting circuit unit 4 is placed on the vicinity of the light emitter 2.

As for the third feature, in the first or second feature, the light emitter 2 includes an LED element.

As for the fourth feature, in any one of the first to third features, the substrate 3 has the first surface 3a and the second surface 3b in the thickness direction of the substrate 3. The light emitter 2 is placed on the first surface 3a of the substrate 3. The second surface 3b of the substrate 3 is a flat surface.

As for the fifth feature, in any one of the first to fourth features, the light emitter 2 is placed on the first surface 3a of the substrate 3 in the thickness direction of the substrate 3. The cover 5 includes: the first part which is placed on the first surface 3a of the substrate 3 to cover the light emitter 2 and is designed to allow light from the light emitter 2 to pass; the second part placed on the first surface 3a of the substrate 3 to not cover the light emitter 2; and the light reflector which is formed on the surface of the second part and is designed to reflect light from the light emitter 2.

Further, the lighting fixture 9 in accordance with the present embodiment includes the light emitting device 100 (110), and the fixture body 91 configured to support the light emitting device 110.

In the lighting fixture 9 of the present embodiment, part of the substrate 3 on which the light emitter 2 and the lighting circuit unit 4 are mounted constitutes part of the housing 8. Hence, heat can be dissipated to the outside via the substrate 3 without using heat dissipating means. Consequently, in contrast to a configuration where a substrate does not constitute a housing, the lighting fixture 9 of the present embodiment can have the improved heat dissipation performance for heat from the light emitter 2 and the lighting circuit unit 4.

Further, according to the lighting fixture 9 of the present embodiment, the housing 8 can be constituted by the substrate 3 and the cover 5. Hence, a housing separate from the substrate 3 and the cover 5 is unnecessary.

Accordingly, the lighting fixture 9 of the present embodiment can satisfy improvement in heat dissipation performance and reduction in the number of parts thereof.

### Second Embodiment

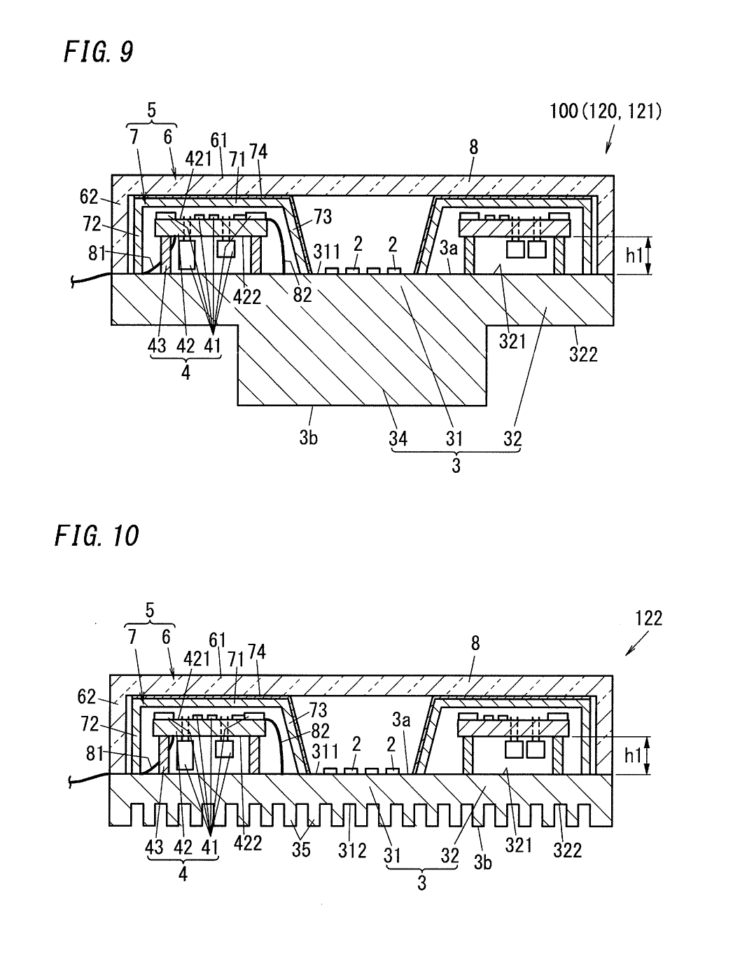

As shown in FIG. 9, the light emitting device 100 (120) of the second embodiment is different from the light emitting device 100 (110) in accordance with the first embodiment (see FIG. 1) in that the substrate 3 is partially recessed or protruded. In other words, the substrate 3 is provided at the second surface 3b with a recessed and protruded structure. Note that, components common to the present embodiment and the light emitting device 110 of the first embodiment are designated by the same reference numerals and explanations thereof are deemed unnecessary. Besides, in FIG. 9, the parts provided with the screw holes 11 (see FIG. 1) are not shown. In the following FIG. 10 to FIG. 12, similarly, such parts are not shown.

FIG. 9 shows a basic example (light emitting device 121) of the light emitting device 120 of the second embodiment. The substrate 3 of the present embodiment includes a protrusion part 34 formed integrally with the light emitter supporting portion 31 and the circuit supporting portion 32. The protrusion part 34 extends downward from the light emitter supporting portion 31 and the circuit supporting portion 32. Note that, explanations are not made to the functions same as those of the substrate 3 (see FIG. 1) of the first embodiment.

The protrusion part 34 is formed into a circular shape in a plane normal to the thickness direction of the substrate 3. Hence, a surface area (heat dissipation area) and a volume of the outer side of the substrate 3 are increased. In brief, the light emitting device 121 includes the protrusion part 34 as the recessed and protruded structure.

FIG. 10 shows a structure corresponding to another example of the light emitting device 120 in accordance with the present embodiment. FIG. 10 shows a first modification (light emitting device 122) of the light emitting device 120 of the present embodiment. As for the light emitting device 122 of FIG. 10, the substrate 3 has the second surface 3b (312, 322) which has a fin structure. In brief, plural fins 35 are provided to the second surface 3b (312, 322). Accordingly, the surface area (i.e., the heat dissipation area) of the second surfaces 312 and 322 of the substrate 3 can be increased. In brief, the light emitting device 122 includes the plural fins 35 as the recessed and protruded structure.

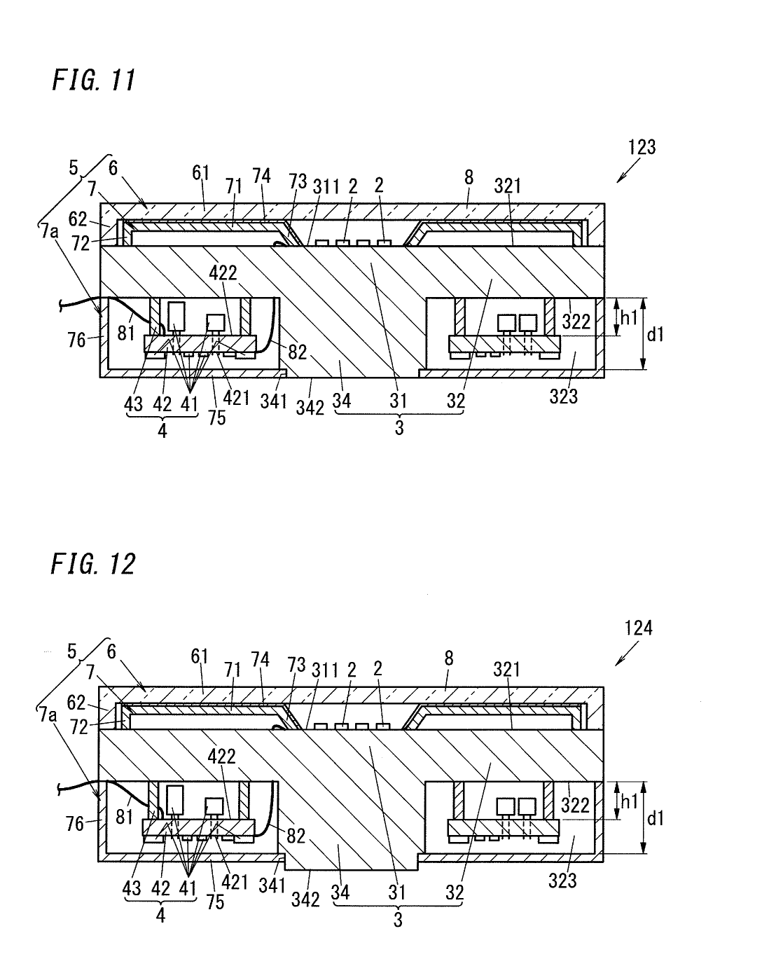

FIG. 11 shows a second modification (light emitting device 123) of the light emitting device 120 of the present embodiment, and FIG. 12 shows a third modification (light emitting device 124) of the light emitting device 120 of the present embodiment. As for the light emitting devices 123 and 124 of FIG. 11 and FIG. 12, the lighting circuit unit 4 is placed in a recessed part 323 formed in the second surface 3b (322) of the substrate 3. The recessed part 323 has a depth d1 which is selected such that the lighting circuit unit 4 is housed in the recessed part 323 without protruding from the recessed part 323. Note that, the recessed part 323 may be filled with resin. In brief, each of the light emitting device 123 and the light emitting device 124 includes the recessed part 323 as the recessed and protruded structure.

Further, as for the light emitting devices 123 and 124 of FIG. 11 and FIG. 12, the cover 5 includes a second cover 7a in addition to the second cover 7. The second cover 7a is used for covering the lighting circuit unit 4 placed on the second surface 322 of the substrate 3.

The second cover 7a includes a lower surface part 75 and a side part 76 which are formed integrally with each other. The lower surface part 75 is formed into a circular ring shape. The side part 76 is formed into a hollow cylindrical shape and extends upward from an outer periphery of the lower surface part 75. The second cover 7a is attached to the substrate 3 by fitting an inner periphery of the lower surface part 75 into the fitting part 341. Thus, it can be easy to attach the second cover 7a to the substrate 3.

In the light emitting device 123 of FIG. 11, the protrusion part 34 has a second surface 342 which is positioned in the same height as that of the lower surface part 75 of the second cover 7a. In contrast, in the light emitting device 124 of FIG. 12, the protrusion part 34 has the second surface 342 which is positioned downward from the lower surface part 75 of the second cover 7a.

Accordingly, the light emitting device 120 (121 to 124) of the present embodiment can increase at least one of the surface are (heat dissipation area) of the outer side of the substrate 3 and the volume (heat capacity) of the substrate 3. Hence, the heat dissipation performance can be more improved.

In brief, the light emitting device 120 of the present embodiment includes the following sixth feature in addition to the first feature. As for the sixth feature, the substrate 3 has the first surface 3a and the second surface 3b in the thickness direction of the substrate 3. The light emitter 2 is placed on the first surface 3a of the substrate 3. The substrate 3 is provided at the second surface 3b with the recessed and protruded structure.

Note that, the light emitting device 120 of the present embodiment may include the second, third, and fifth features selectively.

### Third Embodiment

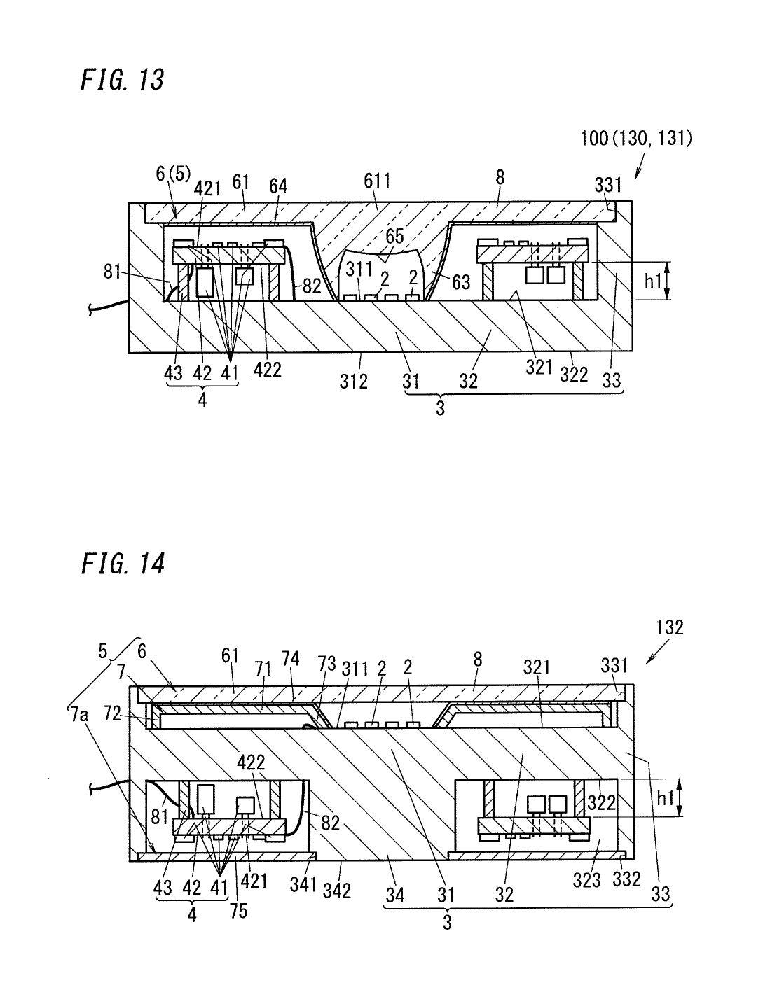

As shown in FIG. 13, the light emitting device 100 (130) of the third embodiment is different from the light emitting device 100 (110) in accordance with the first embodiment (see FIG. 1) in that the substrate 3 is provided with a side part 33. Note that, components common to the present embodiment and the light emitting device 110 of the first embodiment are designated by the same reference numerals and explanations thereof are deemed unnecessary. Besides, in FIG. 13, the parts provided with the screw holes 11 (see FIG. 1) are not shown. In the following FIG. 14, similarly, such parts are not shown.

FIG. 13 shows a basic example (light emitting device 131) of the light emitting device 130 of the third embodiment. The substrate 3 of the present embodiment includes the side part 33 formed integrally with the light emitter supporting portion 31 and the circuit supporting portion 32. The side part 33 extends upward from the outer periphery of circuit supporting portion 32.

The side part 33 is formed into a hollow cylindrical shape, and is provided at its apex with a fitting part 331 designed to catch the first cover 6. Accordingly, the substrate 3 constitutes not only the bottom surface of the housing 8 but also the side surface of the housing 8. Note that, explanations are not made to the functions same as those of the substrate 3 (see FIG. 1) of the first embodiment.

The cover 5 of the present embodiment does not include the second cover 7 but includes the first cover 6 only. The first cover 6 of the present embodiment is devoid of the side part 62, and includes the upper surface part 61 and the protrusion part 63 which are formed integrally with each other. The first cover 6 is fixed to the substrate 3 by fitting the outer periphery of the upper surface part 61 into the fitting part 331 of the side part 33. Note that, explanations are not made to the functions same as those of the first cover 6 (see FIG. 1) of the first embodiment.

FIG. 14 shows another example of the light emitting device 130 in accordance with the present embodiment. In other words, FIG. 14 shows a modification (light emitting device 132) of the light emitting device 130 of the present embodiment. In the light emitting device 132 of FIG. 14, the lighting circuit unit 4 is provided to the recessed part 323 formed in the second surface 322 of the substrate 3. Hence, a side, on which the light emitter 2 is placed, of the light emitting device 132 can be thinned.

Further, as for the light emitting device 132 of FIG. 14, the cover 5 includes the second cover 7a in addition to the second cover 7. The second cover 7a is used for covering the lighting circuit unit 4 placed on the second surface 322 of the substrate 3.

The second cover 7a of the light emitting device 132 is constituted by the lower surface part 75 only, and is formed into a circular ring shape. The second cover 7a is fixed to the substrate 3 by fitting the outer periphery and the inner periphery of the second cover 7a into a fitting part 332 of the side part 33 and the fitting part 341 of the protrusion part 34 respectively. Thus, it can be easy to attach the second cover 7a to the substrate 3.

Accordingly, the light emitting device 130 (131, 132) of the present embodiment can increase the surface are (heat dissipation area) of the outer side of the substrate 3. Hence, the heat dissipation performance can be more improved. Note that, the light emitting device 130 of the present embodiment includes the first feature in a similar manner as the first embodiment. Besides, the light emitting device 130 of the present embodiment may include the second to sixth features selectively.

### Fourth Embodiment

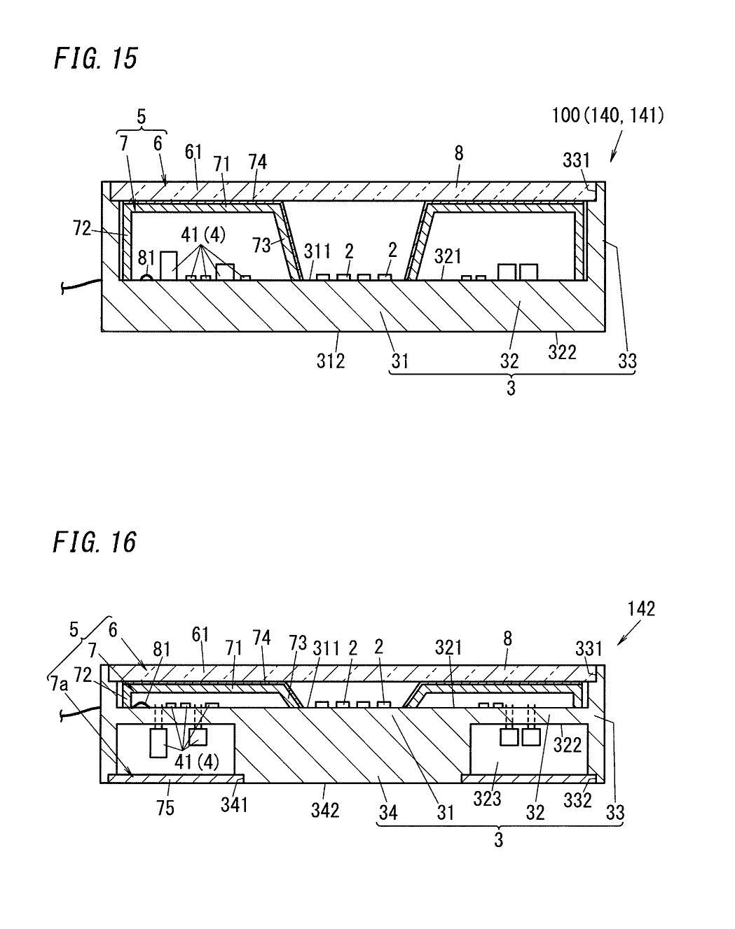

As shown in FIG. 15, the light emitting device 100 (140) of the fourth embodiment is different from the light emitting device 110 in accordance with the first embodiment (see FIG. 1) in that the plural circuit components 41 are directly mounted on the substrate 3 without being supported by the pillars 43. Note that, components common to the present embodiment and the light emitting device 110 of the first embodiment are designated by the same reference numerals and explanations thereof are deemed unnecessary. Besides, in FIG. 15, the parts provided with the screw holes 11 (see FIG. 1) are not shown. In the following FIG. 16, similarly, such parts are not shown.

FIG. 15 shows a basic example (light emitting device 141) of the light emitting device 140 of the fourth embodiment. The plural circuit components 41 of the present embodiment are mounted on not the circuit board 42 but the substrate 3. Thus, the plural circuit components 41 and the light emitter 2 are mounted on the same substrate 3. Accordingly, in contrast to a case where the plural circuit components 41 are mounted on the circuit board 42, a space necessary for placing the circuit component(s) 41 can be reduced.

The substrate 3 of the present embodiment includes the side part 33 formed integrally with the light emitter supporting portion 31 and the circuit supporting portion 32. The side part 33 extends upward from the outer periphery of circuit supporting portion 32. The side part 33 is formed into a hollow cylindrical shape, and is provided at its apex with the fitting part 331 designed to catch the first cover 6. Accordingly, the substrate 3 constitutes not only the bottom surface of the housing 8 but also the side surface of the housing 8. Note that, explanations are not made to the functions same as those of the substrate 3 (see FIG. 1) of the first embodiment.

The first cover 6 of the present embodiment is devoid of the side part 62. The first cover 6 of the present embodiment is fixed to the substrate 3 by fitting the outer periphery of the upper surface part 61 into the fitting part 331 of the side part 33. Note that, explanations are not made to the functions same as those of the first cover 6 (see FIG. 1) of the first embodiment.

FIG. 16 shows another example of the light emitting device 140 in accordance with the present embodiment. In other words, FIG. 16 shows a modification (light emitting device 142) of the light emitting device 140 of the present embodiment. In the light emitting device 142 of FIG. 16, the substrate 3 includes the side part 33 formed integrally with the light emitter supporting portion 31 and the circuit supporting portion 32. The side part 33 extends upward and downward from the outer periphery of circuit supporting portion 32.

The side part 33 is formed into a hollow cylindrical shape. The 33 is provided at its upper end with the fitting part 331 designed to catch the first cover 6 and at its lower end with the fitting part 332 designed to catch the second cover 7a.

Further, as for the light emitting device 142 of FIG. 16, the cover 5 includes the second cover 7a in addition to the second cover 7. The second cover 7a is used for covering the circuit components 41 placed on the second surface 322 of the substrate 3.

The second cover 7a is constituted by the lower surface part 75 only, and is formed into a circular ring shape. The second cover 7a is fixed to the substrate 3 by fitting the outer periphery and the inner periphery of the second cover 7a into the fitting part 332 of the side part 33 and the fitting part 341 of the protrusion part 34 respectively. Thus, it can be easy to attach the second cover 7a to the substrate 3.

In brief, the light emitting device 140 of the present embodiment includes the following seventh feature in addition to the first feature. As for the seventh feature, the circuit component 41 is mounted (placed) on the substrate 3.

Note that, the light emitting device 140 of the present embodiment may include the second to sixth features selectively.

### Fifth Embodiment

As mentioned above, the prior light emitting device disclosed in document 1 has a structure where the lighting circuit unit (the lighting circuit component, the circuit board) is mounted on the rear side of the LED substrate. Hence, a dimension (height) of the light emitting device in the thickness direction of the LED substrate is likely to be increased. In other words, as for the prior light emitting device, to reduce the height of the entire device is difficult.

Further, a decrease in a distance between the LED and the lighting circuit component is likely to cause a problem that heat from the LED may be transferred to the lighting circuit component and heat from the lighting circuit component may be transferred to the LED.

Accordingly, it is desirable that the light emitting device and the lighting fixture can satisfy both of improvement in heat dissipation performance and reduction in height.

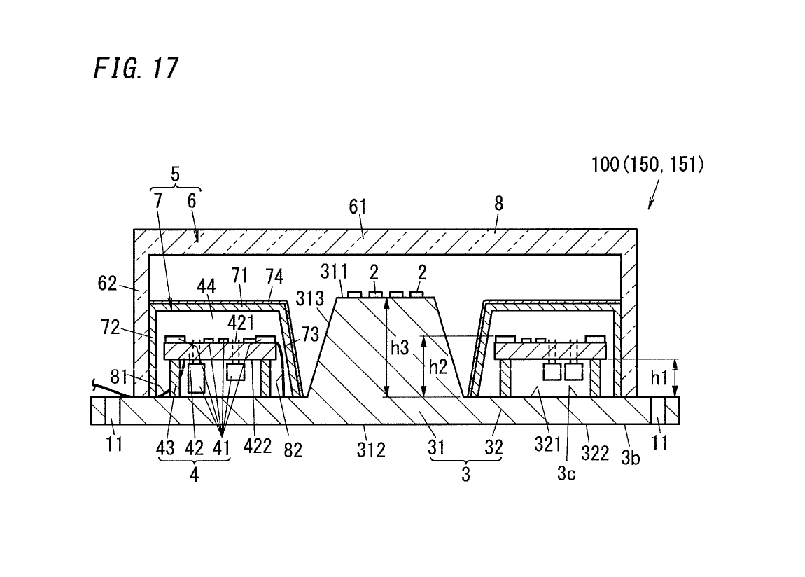

With regard to the following fifth to eighth embodiments, for example, the light emitting device 100 (150) shown in FIG. 17 has a structure in which the light emitter 2 and the lighting circuit unit 4 are placed on the same surface 3a (311, 312) of the substrate 3. In this light emitting device 150, the substrate 3 is provided with a level difference between the light emitter supporting portion 31 on which the light emitter 2 is placed and the circuit supporting portion 32 on which the lighting circuit unit 4 is placed.

The level difference between the light emitter supporting portion 31 and the circuit supporting portion 32 is, for example, a height difference between the light emitter supporting portion 31 and the circuit supporting portion 32, a recessed portion with a bottom interposed between the light emitter supporting portion 31 and the circuit supporting portion 32, or a combination of the height difference and the recessed portion.

According to the light emitting device 100 (150), in contrast to a structure where the light emitter 2 and the lighting circuit unit 4 are placed on mutually different surfaces, the height of the whole device in the thickness direction of the substrate 3 can be lowered. Further, according to the light emitting device 100 (150), in contrast to a structure where no level difference is formed between the light emitter 2 and the lighting circuit unit 4, a heat transfer path between the light emitter 2 and the lighting circuit unit 4 can be lengthened. Hence, heat transfer between the light emitter 2 and the lighting circuit unit 4 can be reduced.

The following explanations are made to the respective embodiments.

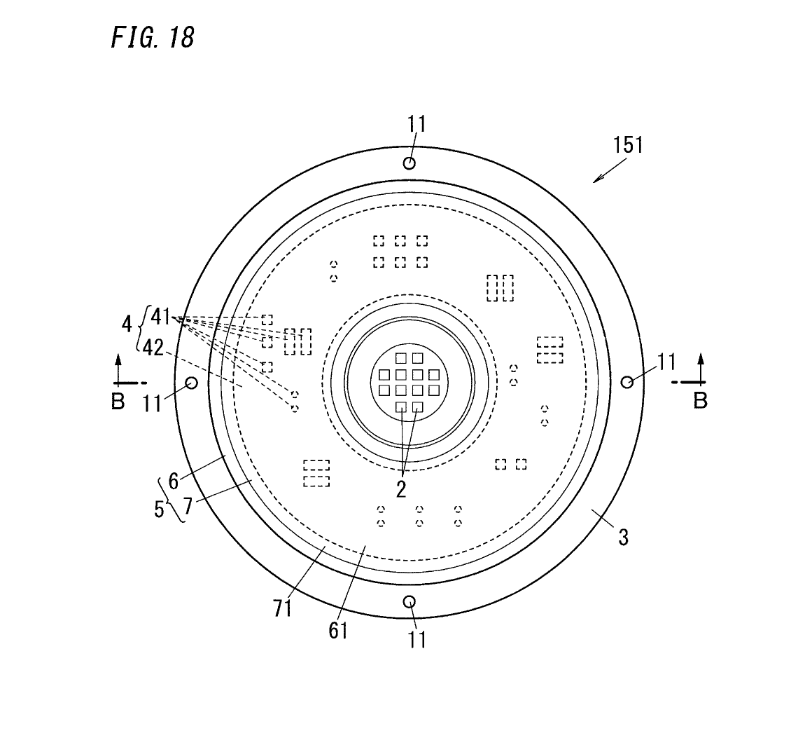

FIG. 18 shows a front view of the light emitting device 100 (150) in accordance with the fifth embodiment, and FIG. 17 shows a sectional view along line B-B in FIG. 18. Note that, FIG. 17 illustrates a basic example (light emitting device 151) regarding the light emitting device 150 of the first embodiment. Further, components common to the present embodiment and the light emitting device 100 of the first embodiment are designated by the same reference numerals and explanations thereof are deemed unnecessary.

In the substrate 3, the level difference is provided between the first surface 311 of the light emitter supporting portion 31 and the first surface 321 of the circuit supporting portion 32. In the substrate 3 of the present embodiment, as shown in FIG. 17, the first surface (mounting surface for the light emitter 2) 311 of the light emitter supporting portion 31 is protruded toward a light emission side relative to the first surface (supporting surface for the lighting circuit unit 4) 321 of the circuit supporting portion 32. In brief, the substrate 3 has a height difference (height h3) between the light emitter supporting portion 31 and the circuit supporting portion 32 in the thickness direction thereof.

The light emitter supporting portion 31 of the present embodiment is formed into a tapered shape, and a side surface 313 thereof is closer to the outside toward a bottom of the light emitter supporting portion 31 than at the first surface 311. In the present embodiment, the side surface 313 defines an uneven portion which has a level difference in the thickness direction and is interposed between the light emitter supporting portion 31 and the circuit supporting portion 32. In other words, the uneven portion is defined by a surface (side surface 313) connecting the first surface (mounting surface) 311 of the light emitter supporting portion 31 on which the light emitter 2 is placed and the first surface (supporting surface) 321 of the circuit supporting portion 32 on which the lighting circuit unit 4 is placed such that the first surface (mounting surface) 311 of the light emitter supporting portion 31 on which the light emitter 2 is placed and the first surface (supporting surface) 321 of the circuit supporting portion 32 on which the lighting circuit unit 4 is placed are positioned at mutually different positions in the thickness direction.

Further, in the present embodiment, contact positions of the substrate 3 and each of the first cover 6 and the second cover 7 of the cover 5 are on the first surface 321 of the circuit supporting portion 32. Thus, the contact positions are below the first surface 311 of the light emitter supporting portion 31.

Furthermore, in the instance shown in FIG. 17, an increase in a difference (h3−h2) between the height h3 for the light emitter 2 and the height h2 of the circuit component 41 of the lighting circuit unit 4 can facilitate modification of the cover 5 and a shape of a lens, and thus it can be easy to provide a lighting with light distribution in line with user's request.

As shown in FIG. 17, the circuit board 42 is placed such that the light emitter supporting portion 31 protruded relative to the circuit supporting portion 32 passes through the inside of the circuit board 42.

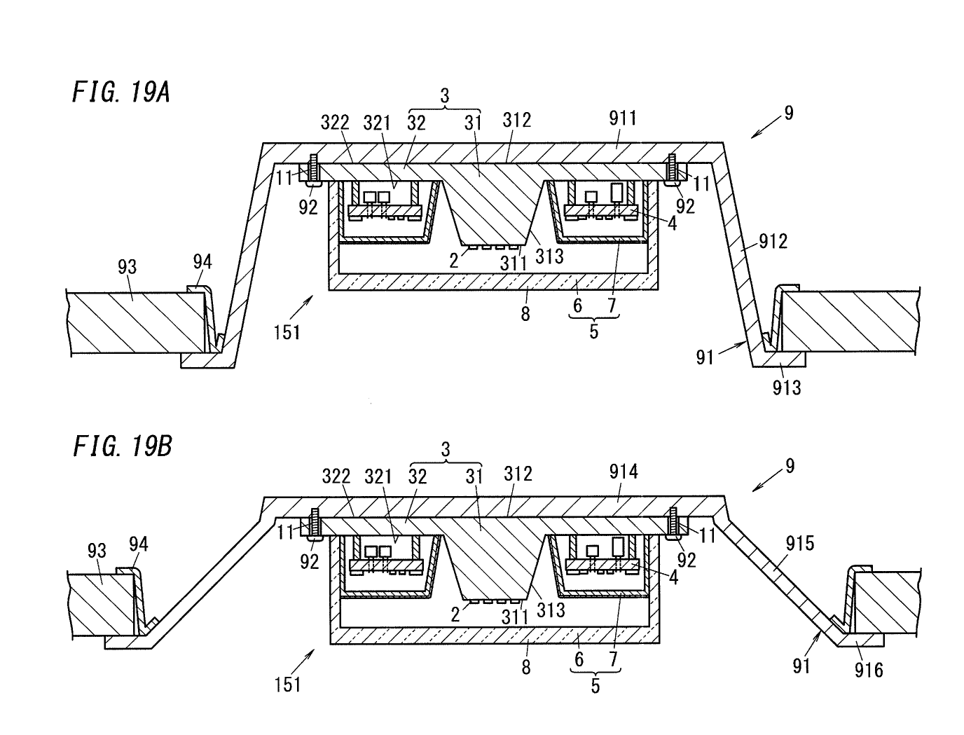

As shown in FIG. 19A and FIG. 19B, the light emitting device 150 explained above is attached to the fixture body 91 and is used as the lighting fixture 9. The lighting fixture 9 is, for example, a lighting fixture for residences or premises (e.g., a downlight). Note that, the application of the lighting fixture 9 is not limited to the aforementioned application, but the lighting fixture 9 may be an apparatus suitable for another application.

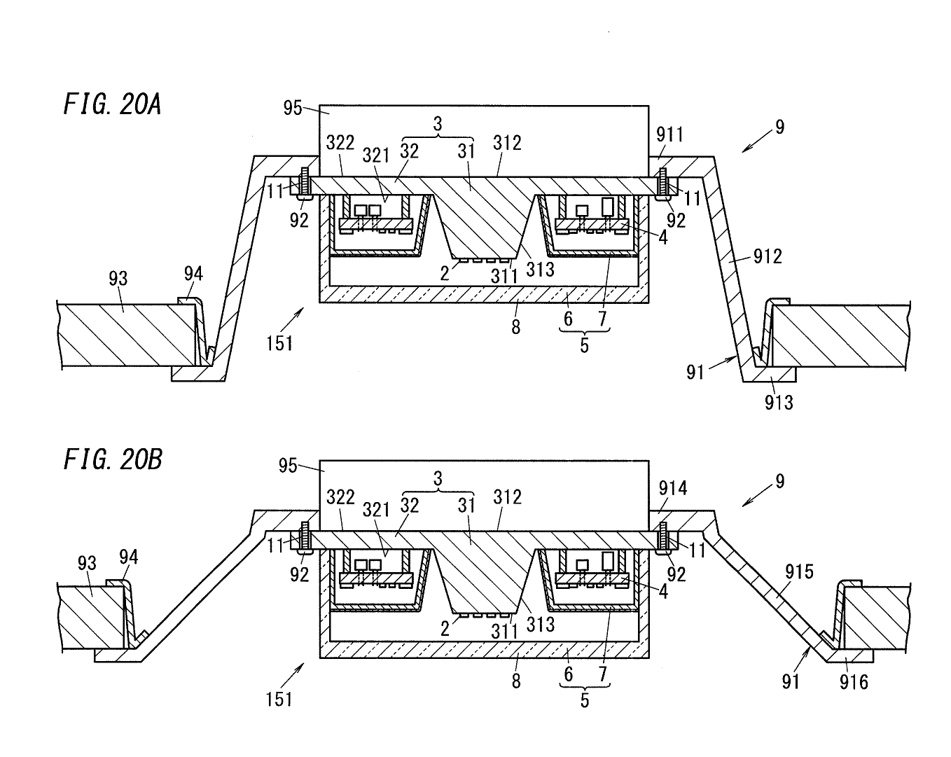

Alternatively, FIG. 20A and FIG. 20B show another example of the lighting fixture 9 of the present embodiment which further includes the heatsink 95. The heatsink 95 is provided to the fixture body 91. In the lighting fixture 9 shown in FIG. 20, the substrate 3 of the light emitting device 150 is in direct contact with the heatsink 95 when the light emitting device 150 is attached to the fixture body 91. Hence, heat dissipation via the substrate 3 can be improved.

The following explanation is made to other examples (modifications) of the light emitting device 150 in accordance with the present embodiment.

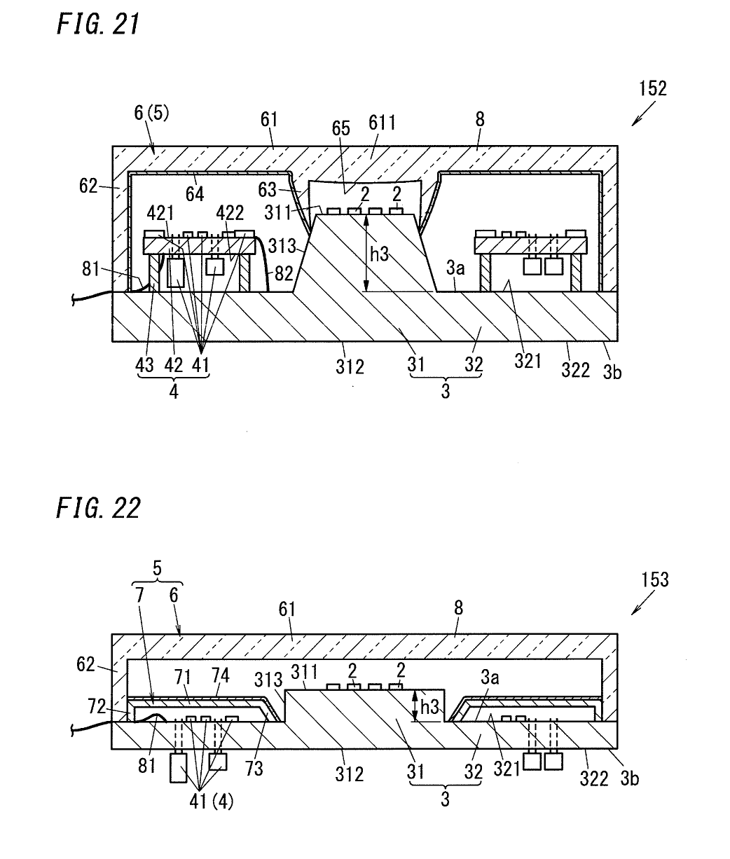

FIG. 21 shows a first modification (light emitting device 152) of the light emitting device 150 of the present embodiment. In the light emitting device 152 of FIG. 21, the cover 5 does not include the second cover 7 but includes the first cover 6 only. Note that, in FIG. 21, the parts provided with the screw holes 11 (see FIG. 1) are not shown. In the following FIG. 22 and FIG. 24, similarly, such parts are not shown.

The first cover 6 of FIG. 21 includes the protrusion part 63 formed integrally with the upper surface part 61 and the side part 62. The protrusion part 63 is formed into a hollow cylindrical shape and extends downward from the central part 611 of the upper surface part 61. The upper surface part 61 and the side part 62 are the same as those of the first cover 6 of FIG. 17. The first cover 6 of FIG. 21 is fixed to the substrate 3 such that the light emitter 2 is housed in a space surrounded by the protrusion part 63. The protrusion part 63 is in contact with the side surface 313 at an apex of the protrusion part 63.

Further, the light reflector (high reflective coating) 64 is formed on a part covering the lighting circuit unit 4 of the inner surface of the first cover 6. For example, the light reflector 64 is formed on an inner surface of part of the upper surface part 61, an inner surface of the side part 62, and an outer surface of the protrusion part 63. Hence, it is possible to reflect light from the light emitter 2 by the light reflector 64.

In the light emitting device 152 of FIG. 21, the first cover 6 includes the part 65 located above the light emitter 2, and the part 65 serves as a lens. Therefore, the number of parts thereof can be reduced relative to an example in which a separated lens is provided to the first cover 6.

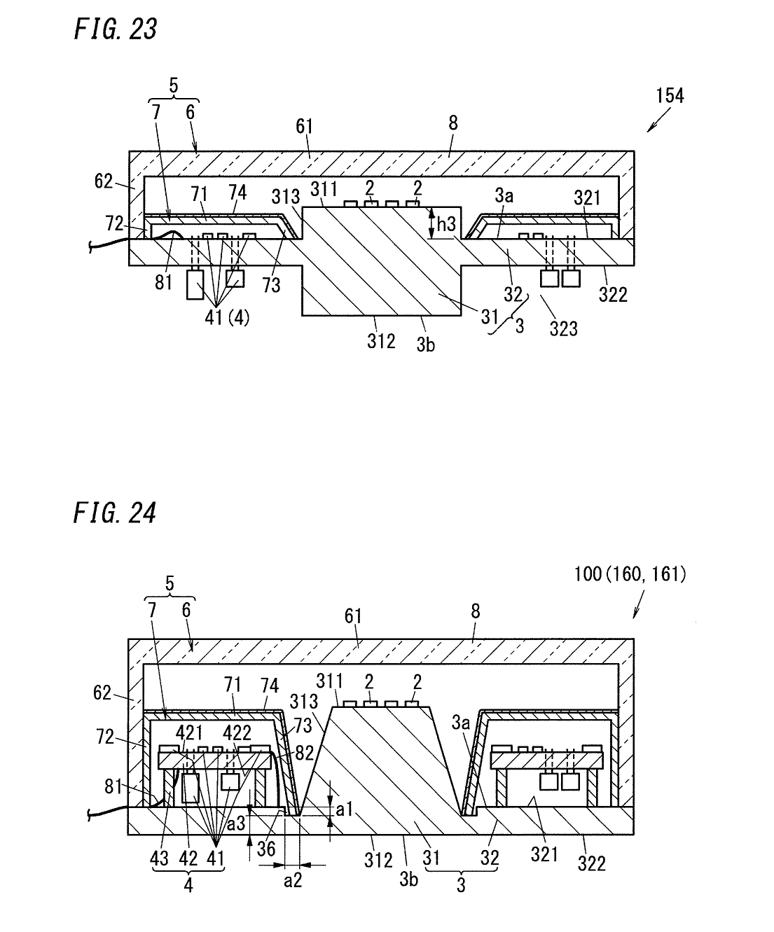

FIG. 22 shows a second modification (light emitting device 153) of the light emitting device 150 of the present embodiment. FIG. 23 shows a third modification (light emitting device 154) of the light emitting device 150 of the present embodiment. In the light emitting devices 153 and 154 of FIG. 22 and FIG. 23, the plural circuit components 41 are directly mounted on the substrate 3 without being supported by the pillars 43.

The light emitter supporting portion 31 of the substrate 3 of FIG. 22 is not formed into a tapered shape. Hence, an outer diameter of the light emitter supporting portion 31 defining a shape of the second surface 312 is constant between the first surface 311 and the bottom of the light emitter supporting portion 31.

In the substrate 3 of FIG. 23, the second surface 312 of the light emitter supporting portion 31 is protruded outside relative to the second surface 322 of the circuit supporting portion 32. Accordingly, a level difference is provided between the second surface 312 of the light emitter supporting portion 31 and the second surface 322 of the circuit supporting portion 32.

In the light emitting device 150 (151 to 154) of the present embodiment explained above, the light emitter 2 and the lighting circuit unit 4 are placed while fixed on the same surface 3a (311, 312) of the substrate 3. According to the light emitting device 150 of the present embodiment, in contrast to a structure where the light emitter and the lighting circuit unit are placed while fixed on mutually different surfaces, the height of the whole device in the thickness direction of the substrate 3 can be lowered.

Further, in the light emitting device 154 of FIG. 23, when the circuit component 41 is placed on the second surface 322 of the circuit supporting portion 32, this circuit component 41 is positioned in a space formed between the second surface 312 of the light emitter supporting portion 31 and the second surface 322 of the circuit supporting portion 32. Hence, it is possible to avoid that the circuit component 41 is protruded relative to the second surface 312 of the 31. Additionally, it is possible to facilitate connecting the light emitting device 154 (the substrate 3) to the fixture body 91 (see FIG. 19).

Furthermore, in the light emitting device 150 of the present embodiment, while the lighting circuit unit 4 is placed in the vicinity of the light emitter 2, the level difference is formed between the light emitter supporting portion 31 and the circuit supporting portion 32. For example, the light emitting device 150 of the present embodiment has the height difference (height h3) between the light emitter supporting portion 31 and the circuit supporting portion 32 in the thickness direction of the substrate 3. According to the light emitting device 150 of the present embodiment, in contrast to a structure where no level difference is formed, that is, the light emitter supporting portion 31 and the circuit supporting portion 32 are flush with each other, a heat transfer path between the light emitter 2 and the lighting circuit unit 4 can be lengthened. Consequently, heat transfer between the light emitter 2 and the lighting circuit unit 4 can be reduced.

Consequently, the light emitting device 150 of the present embodiment can satisfy both of improvement in heat dissipation performance and reduction in height.

Further, according to the light emitting device 150 of the present embodiment, in a process of attaching the second cover 7 for covering the lighting circuit unit 4, it is possible to facilitate positioning of the second cover 7 by use of the height difference between the light emitter supporting portion 31 and the circuit supporting portion 32.

As mentioned above, the light emitting device 150 of the present embodiment includes the following eighth and ninth features in addition to the first feature.

As for the eighth feature, the light emitting device 150 includes the light emitter 2; the substrate 3 having the first surface 3a on which the light emitter 2 is placed; and the lighting circuit unit 4 which includes the circuit component 41 for lighting the light emitter 2 and is placed on the substrate 3. The lighting circuit unit 4 is placed in the vicinity of the light emitter 2 while fixed on the first surface 3a of the substrate 3. The substrate 3 is formed to have the level difference at least in the first surface 3a between the light emitter supporting portion 31 on which the light emitter 2 is placed and the circuit supporting portion 32 on which the lighting circuit unit 4 is placed. Additionally, the light emitting device 150 includes the cover 5 designed to cover the lighting circuit unit 4.

In other words, the light emitter 2 and the lighting circuit unit 4 are placed on the first surface 3a of the substrate 3 in the thickness direction of the substrate 3. The substrate 3 includes the light emitter supporting portion 31 defined as a portion on which the light emitter 2 is placed; the circuit supporting portion 32 defined as a portion on which the lighting circuit unit 4 is placed; and the uneven portion which has the level difference in the thickness direction and is interposed between the light emitter supporting portion 31 and the circuit supporting portion 32.

As for the ninth feature, in the eighth feature, the substrate 3 has the height difference between the light emitter supporting portion 31 and the circuit supporting portion 32 in the thickness direction.

In other words, the uneven portion is defined by the surface (side surface 313) connecting the first surface 311 of the light emitter supporting portion 31 on which the light emitter 2 is placed and the first surface 321 of the circuit supporting portion 32 on which the lighting circuit unit 4 is placed such that the first surface 311 of the light emitter supporting portion 31 on which the light emitter 2 is placed and the first surface 321 of the circuit supporting portion 32 on which the lighting circuit unit 4 is placed are positioned at mutually different positions in the thickness direction.

Note that, the light emitting device 150 of the present embodiment may include the second to seventh features selectively.

Further, the lighting fixture 9 in accordance with the present embodiment includes the light emitting device 100 (150), and the fixture body 91 configured to support the light emitting device 110.

In this lighting fixture 9, the light emitter 2 and the lighting circuit unit 4 are placed while fixed on the same surface 3a of the substrate 3. According to the lighting fixture 9, in contrast to a structure where the light emitter 2 and the lighting circuit unit 4 are placed while fixed on mutually different surfaces, the height of the whole device in the thickness direction of the substrate 3 can be lowered.

Furthermore, in the lighting fixture 9, while the lighting circuit unit 4 is placed in the vicinity of the light emitter 2, the level difference is formed between the light emitter supporting portion 31 and the circuit supporting portion 32. According to the lighting fixture 9, in contrast to a structure where no level difference is formed, a heat transfer path between the light emitter 2 and the lighting circuit unit 4 can be lengthened. Consequently, heat transfer between the light emitter 2 and the lighting circuit unit 4 can be reduced.

Consequently, the lighting fixture 9 of the present embodiment can satisfy both of improvement in heat dissipation performance and reduction in height.

### Sixth Embodiment

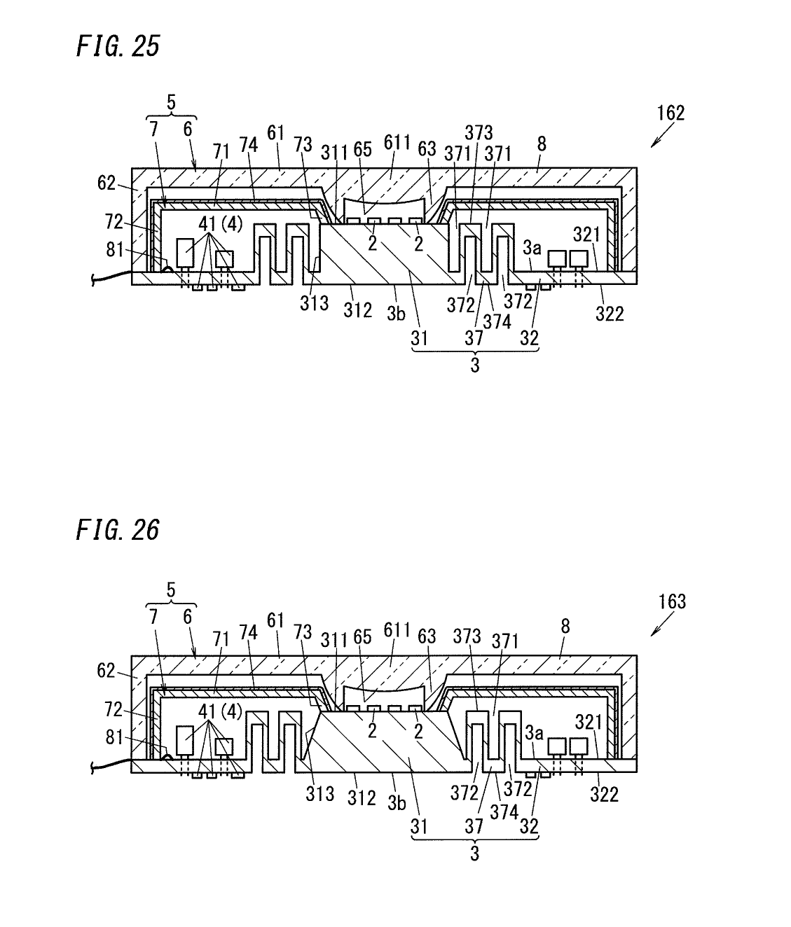

As shown in FIG. 24, the light emitting device 100 (160) of the sixth embodiment is different from the light emitting device 150 in accordance with the fifth embodiment (see FIG. 17) in that the substrate 3 is provided with a groove (recess with a bottom) 36 between the light emitter supporting portion 31 and the circuit supporting portion 32. Accordingly, in the present embodiment, the uneven portion is defined by the recess 36. Note that, components common to the present embodiment and the light emitting device 150 of the fifth embodiment are designated by the same reference numerals and explanations thereof are deemed unnecessary. Besides, in FIG. 24, the parts provided with the screw holes 11 (see FIG. 17) are not shown. In the following FIG. 25 to FIG. 27, similarly, such parts are not shown.

FIG. 24 shows a basic example (light emitting device 161) of the light emitting device 160 of the sixth embodiment. The groove 36 of the present embodiment is formed into a circular ring shape to be interposed between the light emitter supporting portion 31 and the circuit supporting portion 32. This groove 36 is formed such that the sum of a depth a1 (from the first surface 321 of the substrate 3) of the groove 36 and a width a2 of the groove 36 is greater than a distance a3 between a bottom of the groove 36 and the second surface 322. Hence, a thermal path from the light emitter 2 to the lighting circuit unit 4 can be lengthened relative to a distance from the light emitter 2 to the second surfaces 312 and 322. Note that, the shape of the groove 36 is not limited to the circular ring shape, and it is sufficient that the groove 36 is formed to surround the light emitter supporting portion 31.

Further, the second cover 7 of the present embodiment is fixed such that the apex of the inner side part 73 is fitted into the groove 36. Note that, explanations are not made to the functions same as those of the second cover 7 (see FIG. 17) of the fifth embodiment.

FIG. 25 to FIG. 27 show other examples of the light emitting device 160 in accordance with the present embodiment.

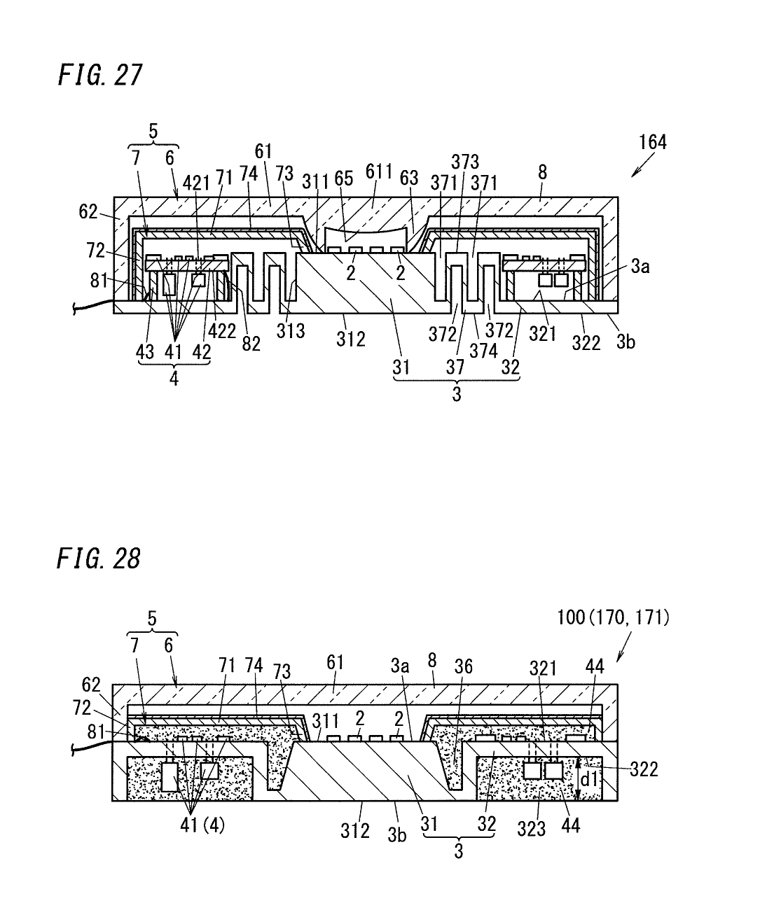

FIG. 25 shows a first modification (light emitting device 162) of the light emitting device 160 of the present embodiment. FIG. 26 shows a second modification (light emitting device 163) of the light emitting device 160 of the present embodiment. FIG. 27 shows a third modification (light emitting device 164) of the light emitting device 160 of the present embodiment. As for the light emitting devices 162 to 164 of FIG. 25 to FIG. 27, an intermediate portion 37 which is provided with plural grooves 371 and 372 is formed between the light emitter supporting portion 31 and the circuit supporting portion 32. In the intermediate portion 37, the groove 371 formed in a first surface 373 and the groove 372 formed in a second surface 374 are arranged alternately. In brief, the intermediate portion 37 has a bellows-like structure.

In the light emitting device 160 (161 to 164) of the present embodiment explained above, the recess (groove 36, 371, 372) is formed between the light emitter supporting portion 31 and the circuit supporting portion 32. According to the light emitting device 160 (161 to 164) of the present embodiment, in contrast to a configuration where no recess is formed between the light emitter supporting portion 31 and the circuit supporting portion 32, a heat transfer path between the light emitter 2 and the lighting circuit unit 4 can be lengthened. Hence, heat transfer between the light emitter 2 and the lighting circuit unit 4 can be reduced.

Specifically, the light emitting device 162 of FIG. 25 employs the intermediate portion 37 with the bellows-like structure. Accordingly, in contrast to the light emitting device 161 of FIG. 24, the light emitting device 162 can have the more lengthened heat transfer path from the light emitter 2 to the lighting circuit unit 4.

Further, in the light emitting device 160 (161 to 164) of the present embodiment, formed between the light emitter supporting portion 31 and the circuit supporting portion 32 is the recess. Hence, in contrast to a structure where a through hole is formed between the light emitter supporting portion and the circuit supporting portion, it is possible to prevent a decrease in strength of the substrate 3.

Furthermore, in the light emitting device 160 (161 to 164) of the present embodiment, it is possible to facilitate positioning of the second cover 7 by use of the recess of the substrate 3.

As mentioned above, the light emitting device 160 of the present embodiment includes the following tenth feature in addition to the first and eighth feature. In the tenth feature, the substrate 3 is provided with the recess (groove 36, 371, 372) between the light emitter supporting portion 31 and the circuit supporting portion 32. In other words, uneven portion is defined by the recess (groove 36, 371, 372). Note that, the light emitting device 160 of the present embodiment may include the second to seventh features selectively.

### Seventh Embodiment

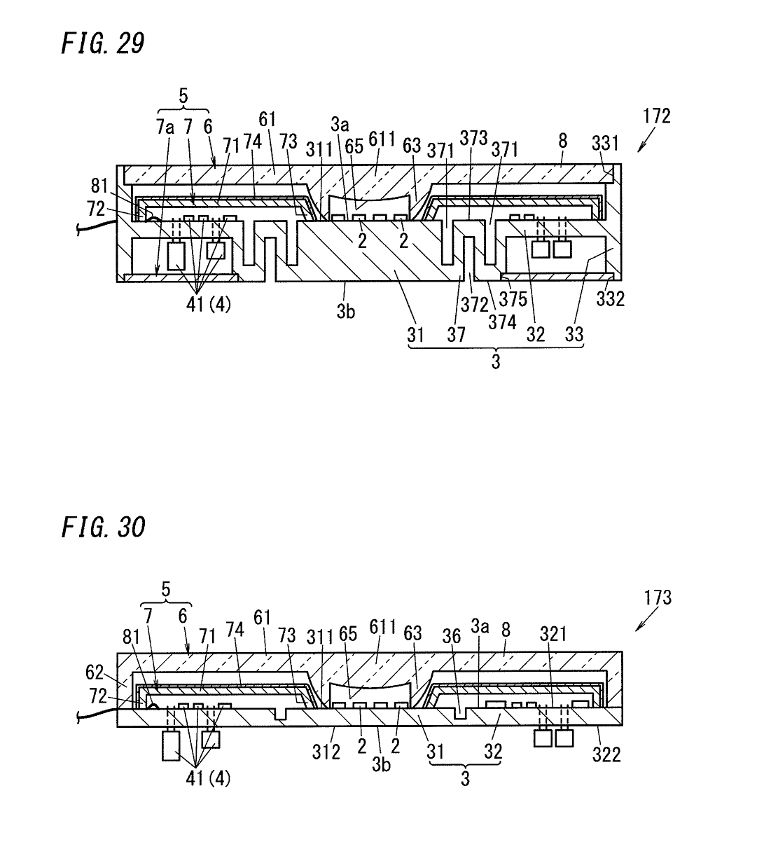

As shown in FIG. 28, the light emitting device 100 (170) of the seventh embodiment is different from the light emitting device 160 in accordance with the sixth embodiment (see FIG. 24) in that the first surface 311 of the light emitter supporting portion 31 and the first surface 321 of the circuit supporting portion 32 are at the same height. Note that, components common to the present embodiment and the light emitting device 160 of the sixth embodiment are designated by the same reference numerals and explanations thereof are deemed unnecessary. Besides, in FIG. 28, the parts provided with the screw holes 11 (see FIG. 17) are not shown. In the following FIG. 29 to FIG. 34, similarly, such parts are not shown.

FIG. 28 shows a basic example (light emitting device 171) of the light emitting device 170 of the sixth embodiment. In the substrate 3 of the present embodiment, the recessed part 323 in the form of a circular ring shape is formed in the second surface 322 of the circuit supporting portion 32. The recessed part 323 has the depth d1 which is selected such that the circuit component 41 is housed in the recessed part 323 without protruding from the recessed part 323. Note that, explanations are not made to the functions same as those of the substrate 3 (see FIG. 24) of the sixth embodiment.

In the lighting circuit unit 4 of the present embodiment, the plural circuit components 41 are not placed on the substrate 3 by use of the pillars 43, but are directly placed on the substrate 3. Note that, in the light emitting device 171 of FIG. 28, the circuit components 41 are mounted on opposite surfaces respectively, but may be mounted on one surface only.

The second cover 7 of the present embodiment is fixed to the first surface 311 of the light emitter supporting portion 31 at the apex of the inner side part 73. In the second cover 7, a space in which the lighting circuit unit 4 is placed is filled with insulating resin 44. Note that, explanations are not made to the functions same as those of the second cover 7 (see FIG. 24) of the sixth embodiment.

FIG. 29 shows a first modification (light emitting device 172) as another example of the light emitting device 170 of the present embodiment. In the light emitting device 172 of FIG. 29, the substrate 3 includes the side part 33 formed integrally with the light emitter supporting portion 31, the circuit supporting portion 32, and the intermediate portion 37. The side part 33 extends upward and downward from the outer periphery of circuit supporting portion 32.

The side part 33 is formed into a hollow cylindrical shape. The 33 is provided at its upper end with the fitting part 331 designed to catch the first cover 6 and at its lower end with the fitting part 332 designed to catch the second cover 7a.

The first cover 6 of FIG. 29 does not include the side part 62, but includes the upper surface part 61 and the protrusion part 63 which are formed integrally with each other. The first cover 6 is fixed to the substrate 3 by fitting the outer periphery of the upper surface part 61 into the fitting part 331. Thus, it can be easy to attach the first cover 6 to the substrate 3.

Further, as for the light emitting devices 172 of FIG. 29, the cover 5 includes the second cover 7a in addition to the second cover 7. The second cover 7a is used for covering the circuit component 41 placed on the second surface 322 of the substrate 3.

The second cover 7a is formed into a circular ring shape. The second cover 7a is fixed to the substrate 3 by fitting the outer periphery and the inner periphery of the second cover 7a into the fitting part 332 of the side part 33 and the fitting part 375 of the intermediate portion 37 respectively.

Thus, it can be easy to attach the second cover 7a to the substrate 3. Note that, a space between the second cover 7a and the second surface 322 of the circuit supporting portion 32 may be filled with resin. Alternatively, such a space may be filled with resin while the second cover 7a is not provided.

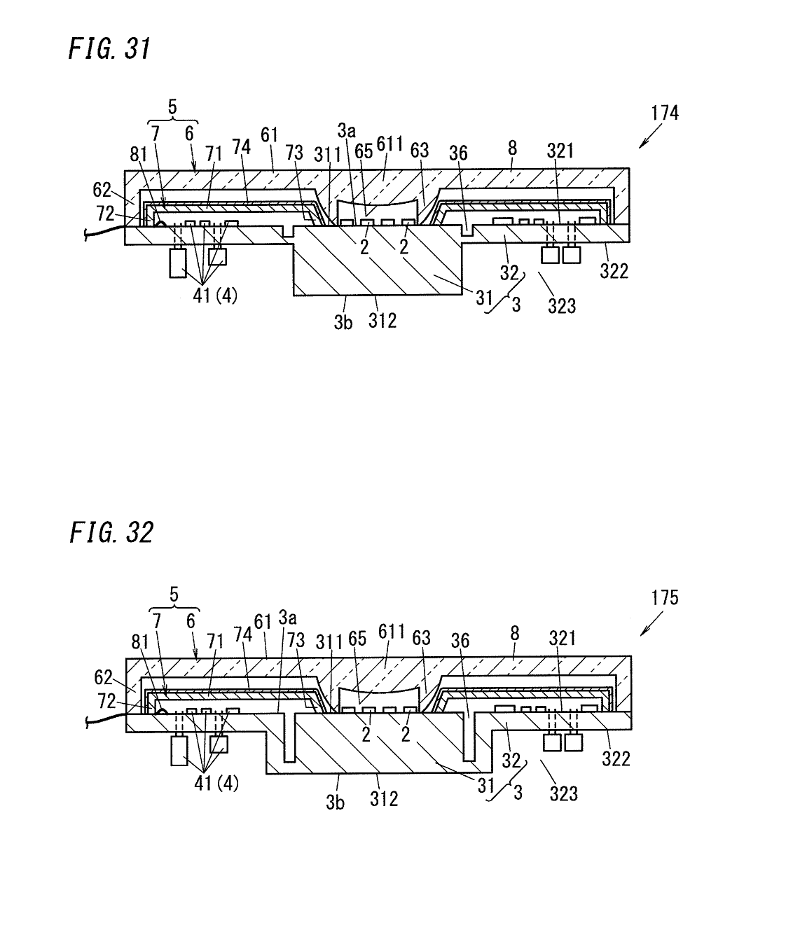

In addition, FIG. 30 to FIG. 32 show other examples (modifications) of the light emitting device 170 in accordance with the present embodiment. FIG. 30 shows a second modification (light emitting device 173) of the light emitting device 170 of the present embodiment. FIG. 31 shows a third modification (light emitting device 174) of the light emitting device 170 of the present embodiment. FIG. 32 shows a third modification (light emitting device 175) of the light emitting device 170 of the present embodiment. Each of the light emitting devices 170 (173 to 175) of FIG. 30 to FIG. 32 has a structure in which the first surface 311 of the light emitter supporting portion 31 and the first surface 321 of the circuit supporting portion 32 are at the same height and the groove 36 is formed between the light emitter supporting portion 31 and the circuit supporting portion 32.

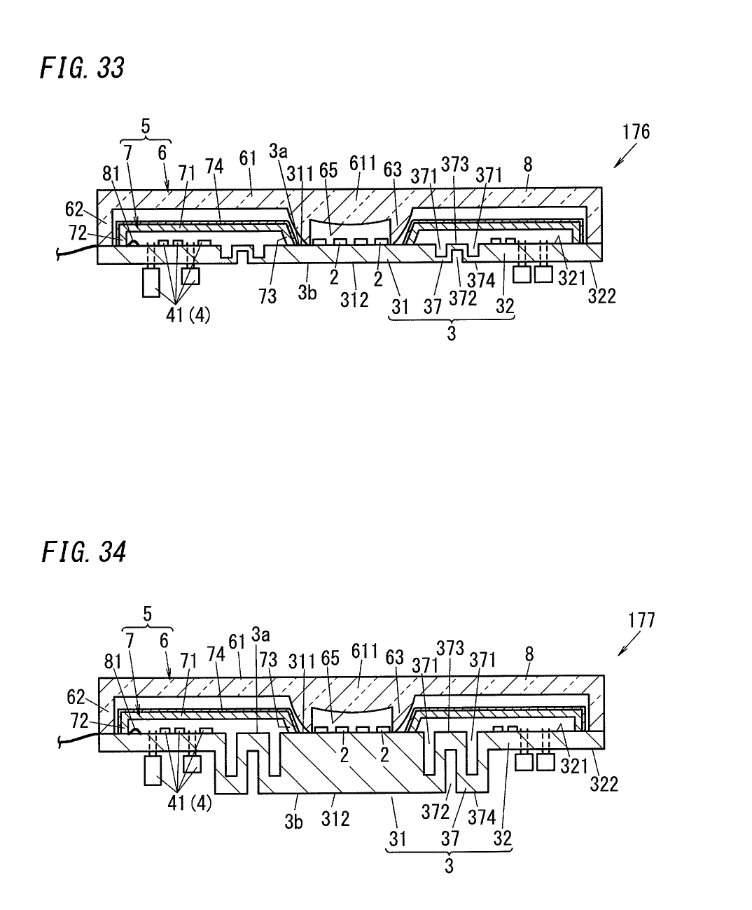

Moreover, FIGS. 33 and 34 show other structures of the light emitting device 170 of the present embodiment. FIG. 33 shows a fifth modification (light emitting device 176) of the light emitting device 170 of the present embodiment. FIG. 34 shows a sixth modification (light emitting device 177) of the light emitting device 170 of the present embodiment. As for the light emitting devices 176 and 177 of FIG. 33 to FIG. 34, the intermediate portion 37 having the bellows-like structure is provided between the light emitter supporting portion 31 and the circuit supporting portion 32. In the intermediate portion 37, the groove 371 formed in the first surface 373 and the groove 372 formed in the second surface 374 are arranged alternately.

In the light emitting device 170 (171 to 177) of the present embodiment explained above, like the sixth embodiment, the recess (groove 36, 371, 372) is formed between the light emitter supporting portion 31 and the circuit supporting portion 32. According to the light emitting device 170 (171 to 177) of the present embodiment, in contrast to a configuration where no recess is formed between the light emitter supporting portion 31 and the circuit supporting portion 32, a heat transfer path between the light emitter 2 and the lighting circuit unit 4 can be lengthened. Hence, heat transfer between the light emitter 2 and the lighting circuit unit 4 can be reduced.

Specifically, the light emitting device 172 of FIG. 29 employs the intermediate portion 37 with the bellows-like structure. Accordingly, in contrast to the light emitting device 171 of FIG. 28, the light emitting device 172 can have the more lengthened heat transfer path from the light emitter 2 to the lighting circuit unit 4.

As mentioned above, the light emitting device 170 of the present embodiment includes the tenth feature in addition to the first and eighth features like the light emitting device 160 of the sixth embodiment. Note that, the light emitting device 170 of the present embodiment includes the second to seventh features selectively.

### Eighth Embodiment

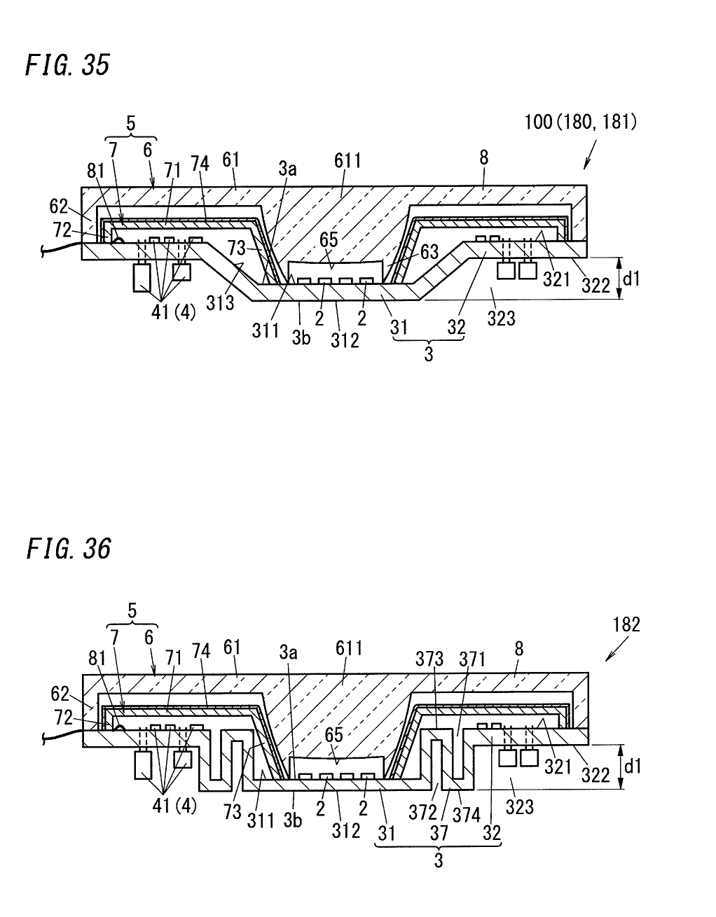

As shown in FIG. 35, the light emitting device 100 (180) of the eighth embodiment is different from the light emitting device 150 in accordance with the fifth embodiment (see FIG. 17) in that the light emitter supporting portion 31 is recessed (set back) relative to the circuit supporting portion 32. Note that, components common to the present embodiment and the light emitting device 150 of the fifth embodiment are designated by the same reference numerals and explanations thereof are deemed unnecessary. Besides, in FIG. 35, the parts provided with the screw holes 11 (see FIG. 17) are not shown. In the following FIG. 36, similarly, such parts are not shown.

FIG. 35 illustrates a basic example (light emitting device 181) regarding the light emitting device 180 of the eighth embodiment. In the substrate 3 of the present embodiment, the light emitter supporting portion 31 is formed into a tapered shape, and the side surface 313 thereof is closer to the center of the light emitter supporting portion 31 toward the first surface 321 than at the first surface 311. In other words, as for the light emitting device 181, the uneven portion is defined by the surface (side surface 313) connecting the mounting surface 311 and the supporting surface 321 such that the mounting surface 311 and the supporting surface 321 are positioned at mutually different positions in the thickness direction.

Further, the recessed part 323 in the form of a circular ring shape is formed in the second surface 322 of the circuit supporting portion 32. Some circuit components 41 are accommodated in the recessed part 323. The recessed part 323 has the depth d1 which is selected such that the circuit component 41 is housed in the recessed part 323 without protruding from the recessed part 323.

FIG. 36 shows a structure representing a modification (light emitting device 182) as another example of the light emitting device 180 in accordance with the present embodiment. The light emitting device 182 of FIG. 36 includes the intermediate portion 37 with the bellows-like structure between the light emitter supporting portion 31 and the circuit supporting portion 32 while the light emitter supporting portion 31 is recessed relative to the circuit supporting portion 32. As for the intermediate portion 37, the groove 371 in the first surface 373 and the groove 372 in the second surface 374 are arranged alternately. Accordingly, in the light emitting device 182, the uneven portion is defined by the recess (groove 371, 372).

In the light emitting device 180 (181 and 182) of the present embodiment explained above, like the light emitting device 150 of the fifth embodiment, the light emitter 2 and the lighting circuit unit 4 are placed while fixed on the same surface 3a (311, 312) of the substrate 3. According to the light emitting device 180 (181 and 182) of the present embodiment, in contrast to a structure where the light emitter and the lighting circuit unit are placed while fixed on mutually different surfaces, the height of the whole device in the thickness direction of the substrate 3 can be lowered.

Further, in the light emitting device 180 (181 and 182) of the present embodiment, like the light emitting device 150 of the fifth embodiment, while the lighting circuit unit 4 is placed in the vicinity of the light emitter 2, the level difference is formed between the light emitter supporting portion 31 and the circuit supporting portion 32. According to the light emitting device 180 (181 and 182) of the present embodiment, in contrast to a structure where no level difference is formed, a heat transfer path between the light emitter 2 and the lighting circuit unit 4 can be lengthened. Consequently, heat transfer between the light emitter 2 and the lighting circuit unit 4 can be reduced.

Accordingly, the light emitting device 181 of the present embodiment includes the following ninth feature in addition to the first and eighth features, like the light emitting device 150 of the fifth embodiment.

Meanwhile, the light emitting device 182 of FIG. 36 employs the intermediate portion 37 with the bellows-like structure. Accordingly, in contrast to the light emitting device 181 of FIG. 35, the light emitting device 182 can have the more lengthened heat transfer path from the light emitter 2 to the lighting circuit unit 4.

Accordingly, the light emitting device 182 of the present embodiment includes the following tenth feature in addition to the first and eighth features, like the light emitting device 160 of the sixth embodiment.

Consequently, the light emitting device 180 (181 and 182) of the present embodiment can satisfy both of improvement in heat dissipation performance and reduction in height, like the light emitting device 150 of the fifth embodiment. Note that, the light emitting device 180 (181 and 182) of the present embodiment may include the second to seventh features selectively.

Note that, each of the light emitting devices 100 (110, 120, 130, 140, 150, 160, 170, and 180) of the respective embodiments can be attached to the fixture body 91 shown in FIG. 3 or FIG. 4 and used as the lighting fixture 9. The light emitting device 100 may be fixed to the flat plate part 911 of the fixture body 91 by means of inserting the screws 92 into the screw holes 11, or by use of bolts and nuts. Alternatively, the light emitting device 100 may be provided with a base and the fixture body 91 may be provided with a support. In this case, the light emitting device 100 may be fixed to the fixture body 91 by inserting the base into the support to make a screw connection. In another example, the fixture body 91 may be provided with one of a recess member and a protrusion member and the light emitting device 100 may be provided with the other. In this example, the light emitting device 100 may be fixed to the fixture body 91 by fitting these members with each other to make a fitting connection.

Besides, an electrical connection between the fixture body 91 and the light emitting device 100 may be made by providing a power cable to the light emitting device 100 and connecting the power cable to the fixture body 91, or by providing a power terminal (e.g., a pin) to the light emitting device 100 and connecting the power terminal to the fixture body 91.

1. A light emitting device comprising:
a light emitter;
a lighting circuit unit including a circuit component for lighting the light emitter; and
a housing configured to accommodate the light emitter and the lighting circuit unit,
wherein
the housing is constituted by:
a substrate on which the light emitter and the lighting circuit unit are placed; and
a cover attached to the substrate to cover the light emitter and the lighting circuit unit.

2. The light emitting device as set forth in claim 1, wherein:
the light emitter is placed on a first surface of the substrate in a thickness direction of the substrate; and
the lighting circuit unit is placed on a vicinity of the lighting emitter.

3. The light emitting device as set forth in claim 1, wherein:
the light emitter and the lighting circuit unit are placed on a first surface of the substrate in a thickness direction of the substrate;
the substrate comprises:
a light emitter supporting portion defined as a portion on which the light emitter is placed;
a circuit supporting portion defined as a portion on which the lighting circuit unit is placed; and
an uneven portion which has a level difference in the thickness direction and is interposed between the light emitter supporting portion and the circuit supporting portion.

4. The light emitting device as set forth in claim 3, wherein:
the uneven portion is defined by a surface connecting a first surface of the light emitter supporting portion on which the light emitter is placed and a first surface of the circuit supporting portion on which the lighting circuit unit is placed such that the first surface of the light emitter supporting portion on which the light emitter is placed and the first surface of the circuit supporting portion on which the lighting circuit unit is placed are positioned at mutually different positions in the thickness direction.

5. The light emitting device as set forth in claim 3, wherein:
the uneven portion is defined by a recessed part.

6. The light emitting device as set forth in claim 1, wherein:
the circuit component is placed on the substrate.

7. The light emitting device as set forth in claim 1, wherein:
the light emitter comprises an LED element.

8. The light emitting device as set forth in claim 1, wherein:
the substrate has a first surface and a second surface in a thickness direction of the substrate;
the light emitter is placed on the first surface of the substrate; and
the second surface of the substrate is a flat surface.

9. The light emitting device as set forth in claim 1, wherein:
the substrate has a first surface and a second surface in a thickness direction of the substrate;
the light emitter is placed on the first surface of the substrate; and
the substrate is provided at the second surface with a recessed and protruded structure.

10. The light emitting device as set forth in claim 1, wherein:
the light emitter is placed on a first surface of the substrate in a thickness direction of the substrate;
the cover comprises:
a first part which is placed on the first surface of the substrate to cover the light emitter and is designed to allow light from the light emitter to pass;
a second part placed on the first surface of the substrate to not cover the light emitter; and
a light reflector which is formed on a surface of the second part and is designed to reflect light from the light emitter.

11. A lighting fixture comprising:
a light emitting device according to claim 1; and
a fixture body configured to support the light emitting device.
